(19) United States
(12) Patent Application Publication
(10) Pub. No.: US 2024/0323980 A1
(43) Pub. Date: Sep. 26, 2024

(54) IMPACT OF MORE THAN ONE PDSCH PER SLOT ON HARQ-ACK CODEBOOK FOR MULTICAST

(71) Applicant: QUALCOMM Incorporated, San Diego, CA (US)

(72) Inventors: Mostafa KHOSHNEVISAN, San Diego, CA (US); Le LIU, San Jose, CA (US); Alberto RICO ALVARINO, San Diego, CA (US); Peter GAAL, San Diego, CA (US)

(21) Appl. No.: 18/437,914

(22) Filed: Feb. 9, 2024

Related U.S. Application Data
(60) Provisional application No. 63/491,517, filed on Mar. 21, 2023.

(51) Int. Cl. H04W 72/30; H04L 1/1812; H04L 1/1829; H04W 72/0446

(52) U.S. Cl. CPC H04W 72/30; H04L 1/1812; H04L 1/1861; H04W 72/0446

(57) ABSTRACT

Various technologies pertaining to an impact of more than one PDSCH per slot on a HARQ-ACK CB for multicast are described herein. A UE receives RRC signaling indicating whether more than one PDSCH is configured for at least one slot associated with at least one HARQ-ACK codebook. The UE performs, for the at least one HARQ-ACK codebook for multiplexing feedback between unicast and multicast for HARQ-ACK, one of: an addition of a candidate PDSCH occasion to a set of candidate PDSCH occasions for the at least one slot based on the RRC signaling or TDRA grouping for the at least one slot based on the RRC signaling.

### CROSS REFERENCE TO RELATED APPLICATION(S)

This application claims the benefit of and priority to U.S. Provisional Application Ser. No. 63/491,517, entitled “IMPACT OF MORE THAN ONE PDSCH PER SLOT ON HARQ-ACK CODEBOOK FOR MULTICAST” and filed on Mar. 21, 2023, which is expressly incorporated by reference herein in its entirety.

### TECHNICAL FIELD

The present disclosure relates generally to communication systems, and more particularly, to hybrid automatic repeat request (HARQ) acknowledgment (ACK) (HARQ-ACK) codebooks.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (cMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus for wireless communication at a user equipment (UE) are provided. The apparatus includes at least one memory; and at least one processor coupled to the at least one memory and, based at least in part on information stored in the at least one memory, the at least one processor, individually or in any combination, is configured to receive radio resource control (RRC) signaling indicating whether more than one physical downlink shared channel (PDSCH) is configured for at least one slot associated with at least one hybrid automatic repeat request (HARQ) acknowledgment (ACK) (HARQ-ACK) codebook; and perform, for the at least one HARQ-ACK codebook for multiplexing feedback between unicast and multicast for HARQ-ACK, one of: an addition of a candidate PDSCH occasion to a set of candidate PDSCH occasions for the at least one slot based on the RRC signaling; or time domain resource allocation (TDRA) grouping for the at least one slot based on the RRC signaling.

In an aspect of the disclosure, a method, a computer-readable medium, and an apparatus for wireless communication at a network node are provided. The apparatus includes at least one memory; and at least one processor coupled to the at least one memory and, based at least in part on information stored in the at least one memory, the at least one processor, individually or in any combination, is configured to transmit, for a user equipment (UE), radio resource control (RRC) signaling indicating whether more than one physical downlink shared channel (PDSCH) is configured for at least one slot associated with at least one hybrid automatic repeat request (HARQ) acknowledgment (ACK) (HARQ-ACK) codebook; and receive, based upon the RRC signaling, HARQ-ACK feedback, where the HARQ-ACK feedback is multiplexed between unicast and multicast.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating examples of frequency division multiplexing (FDM) and time division multiplexing (TDM) for unicast and multicast.

FIG. 5 is a diagram illustrating an example of multiplexing unicast and multicast feedback on a physical uplink control channel (PUCCH).

FIG. 6 is a diagram illustrating an example of interpreting Type 1 hybrid automatic repeat request (HARQ) acknowledgment (ACK) (HARQ-ACK) codebook (CB) pseudocode in the presence of HARQ-ACK for multicast.

FIG. 7 is a diagram illustrating example aspects of additional overhead pertaining to FDM and TDM with respect to multicast.

FIG. 8 is a diagram illustrating an example of aspects pertaining to radio resource control (RRC) parameters.

FIG. 9 is a diagram illustrating another example of aspects pertaining to RRC parameters.

FIG. 10 is a diagram illustrating example communications between a UE and a base station.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication

FIG. 15 is a diagram illustrating an example of a hardware implementation for an example apparatus and/or network entity.

FIG. 16 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

A UE may be configured with the ability to receive one PDSCH per slot or the UE may be configured with the ability to receive more than one PDSCH per slot, where the aforementioned PDSCHs may be or include unicast PDSCHs(s) or multicast PDSCH(s). A manner in which a UE generates a type 1 HARQ-ACK codebook may be affected by whether or not the UE is configured with the ability to receive more than one PDSCH per slot, codebook types associated with multiplexing unicast and multicast HARQ-ACK feedback, priorities associated with codebook types, whether FDM or TDM is used for multiplexing, and/or a type of codebook generation mode. Furthermore, different manners of generating type 1 HARQ-ACK codebooks may result in different sizes for the type 1 HARQ-ACK codebooks. However, a network node may not be able to enable or disable the ability of the UE to receive more than one PDSCH per slot. In an example, a UE that is capable of receiving more than one PDSCH per slot may generate a type 1 HARQ-ACK codebook in a first manner, but the network may not support the capability of the UE receiving more than one PDSCH per slot. As a result, the type 1 HARQ-ACK codebook may have a size that is greater than a size of a type 1 HARQ-ACK codebook that would result had the UE generated the type 1 HARQ-ACK codebook in a second manner associated with the network not supporting the capability of the UE of receiving more than one PDSCH per slot.

Various aspects relate generally to HARQ-ACK codebooks. Some aspects more specifically relate to the impact of more than one PDSCH per slot on a type 1 HARQ-ACK codebook for multicast. In an example, a UE receives RRC signaling indicating whether more than one PDSCH is configured for at least one slot associated with at least one HARQ-ACK codebook. The UE performs, for the at least one HARQ-ACK codebook for multiplexing feedback between unicast and multicast for HARQ-ACK, one of: an addition of a candidate PDSCH occasion to a set of candidate PDSCH occasions for the at least one slot based on the RRC signaling or TDRA grouping for the at least one slot based on the RRC signaling.

Particular aspects of the subject matter described in this disclosure can be implemented to realize one or more of the following potential advantages. In some examples, by performing an addition of a candidate PDSCH occasion or performing TDRA grouping based on the RRC signaling, the described techniques can be used to conserve resources of the UE associated with codebook generation.

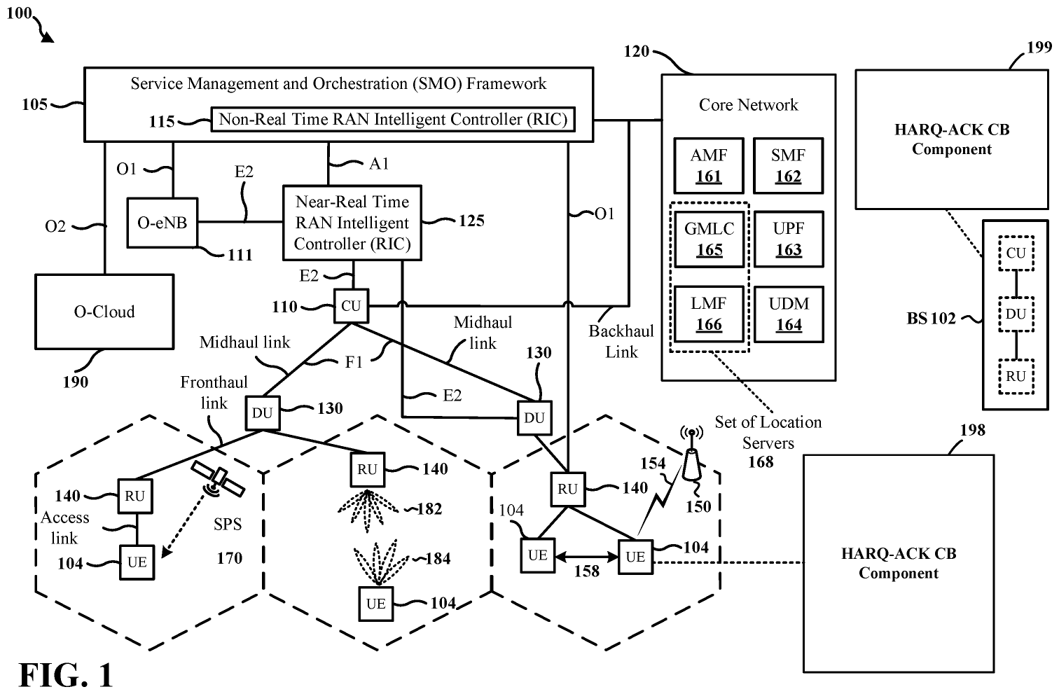

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-CNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FRI, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a HARQ-ACK CB component 198 that may be configured to receive RRC signaling indicating whether more than one PDSCH is configured for at least one slot associated with at least one HARQ-ACK codebook; and perform, for the at least one HARQ-ACK codebook for multiplexing feedback between unicast and multicast for HARQ-ACK, one of: an addition of a candidate PDSCH occasion to a set of candidate PDSCH occasions for the at least one slot based on the RRC signaling; or TDRA grouping for the at least one slot based on the RRC signaling. In certain aspects, the base station 102 may have a HARQ-ACK CB component 199 that may be configured to transmit, for a UE, RRC signaling indicating whether more than one PDSCH is configured for at least one slot associated with at least one HARQ-ACK codebook; and receive, based upon the RRC signaling, HARQ-ACK feedback, where the HARQ-ACK feedback is multiplexed between unicast and multicast. Although the following description may be focused on 5G NR, the concepts described herein may also be applicable to other types of communication systems as well.

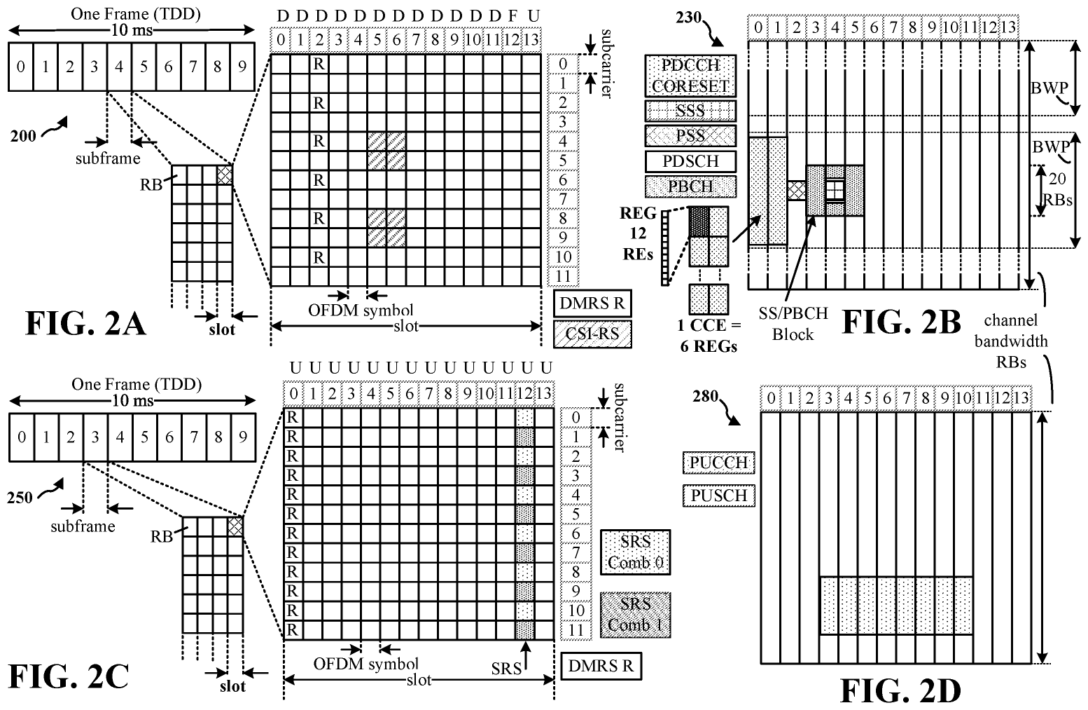

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

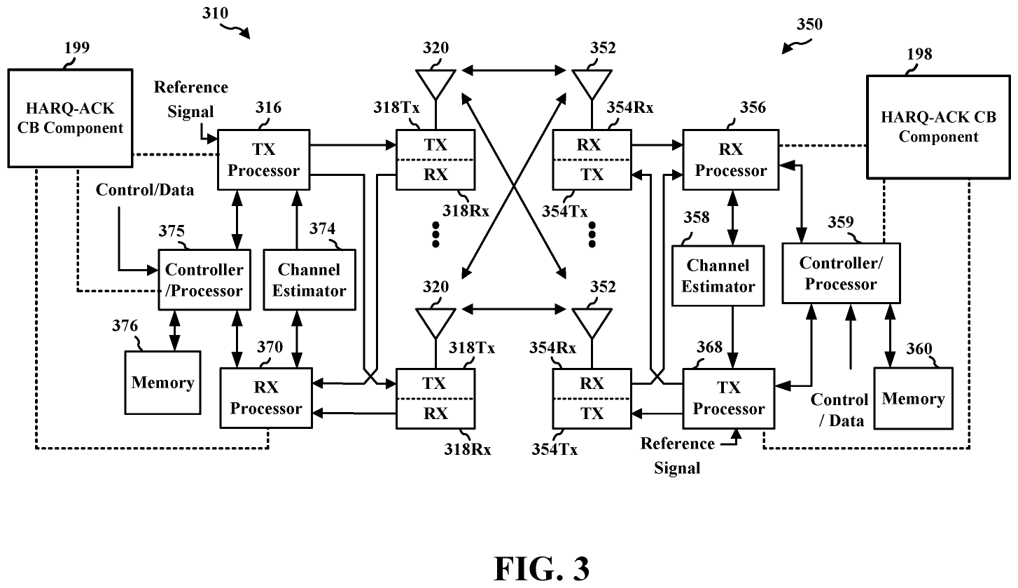

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the HARQ-ACK CB component 198 of FIG. 1.

At least one of the TX processor 316, the RX processor 370, and the controller/processor 375 may be configured to perform aspects in connection with the HARQ-ACK CB component 199 of FIG. 1.

A HARQ-ACK codebook may refer to a sequence of bits constructed using ACK/NACK feedback of multiple PDSCH receptions for a configured time window. A HARQ-ACK codebook may be a type 1 HARQ-ACK codebook or a type 2 HARQ-ACK codebook. A type 1 HARQ-ACK codebook may be determined via semi-static information based on a set of candidate PDSCH occasions. For instance, a type 1 HARQ-ACK codebook may be a fixed size codebook provided by a network node (e.g., a gNB) via RRC signaling. A UE may not account for PDCCH monitoring occasions when determining a type 1 HARQ-ACK codebook. A type 2 HARQ-ACK codebook may have a dynamic size that changes according to resource allocation.

With respect to a type 1 HARQ-ACK codebook, the set of candidate PDSCH occasions may be determined by a UE on a per DL serving cell basis. A set of configured K1 values may be fixed or indicated to the UE via RRC signaling, where the configured set of K1 values indicate a set of possible timing offset values between a PDSCH transmission and a HARQ-ACK transmission. A DCI may indicate a K1 value in the set of configured K1 values. In an example, the set of configured K1 values may be {1, 2, 3, 4, 5, 6, 7, 8} if DCI 1_0 is configured and DCI 1_1 is not configured in a serving cell. In another example, if DCI format 1_1/1_2 is configured for the serving cell, the set of configured K1 values may be provided by a dl-DataToUL-ACK RRC parameter.

After determining the set of possible timing offset values, the UE may “look back” from a slot associated with HARQ-ACK feedback and determine which slots may have a PDSCH transmission, where each of the slots may correspond to one of the set of configured K1 values. For each slot, the UE may determine a set of PDSCH time domain resource allocation (TDRA) candidates corresponding to a start and length indicator value (SLIV) within a slot. A SLIV may be used for time domain resource allocation for a PDSCH and PUSCH. The UE may remove TDRA candidates in the set of PDSCH TDRA candidates that overlap with semi-static uplink symbols. The UE may group remaining TDRA rows such that a number of groups equals a maximum number of non-overlapping SLIVs in a slot.

After grouping the remaining TDRA rows, the UE may generate a type 1 HARQ-ACK codebook in two steps. In a first step, the UE may determine PDSCH occasions. In a second step, the UE may determine the type 1 HARQ-ACK codebook based on the PDSCH occasions determined in the first step.

In an example, the UE may determine the type 1 HARQ-ACK codebook using the pseudocode listed below.

```
while k < [symbol]  (K₁)
    . . .
    if the UE does not indicate a capability to receive more than one
unicast PDSCH or multicast PDSCH per slot and R ≠ 0,
      M_{A,c} = M_{A,c} ∪ j;
      j = j + 1;
    else
    . . . // The else part of the pseudocode performs TDRA grouping to
find a maximum number of non-overlapping SLIVs in a slot. Then, each
group adds one place (j) to a set of occasions for candidate PDSCH
receptions (M_{A,c})
  end if
    k = k + 1;
end while
```

In the pseudocode listed above, [symbol] (K₁) may refer to a cardinality of a set of slot offset values, R may refer to a set of SLIVs corresponding to TDRA rows, M_{A,c} may refer to a set of occasions for candidate PDSCH receptions for a serving cell c, and j may refer to an index of an occasion for a candidate PDSCH reception.

In the pseudocode listed above, when the “if” condition is true, a UE may add one candidate PDSCH occasion to a set of candidate PDSCH occasions per slot (within slots determined by a set of slot offset values K1) per CC for the purpose of type 1 HARQ-ACK generation for a codebook or sub-codebooks (e.g., a unicast HARQ-ACK sub-codebook, a multicast HARQ-ACK sub-codebook). Hence, the UE may not perform TDRA grouping to find a maximum number of non-overlapping SLIVs in a slot when the “if” condition is true in the pseudocode. In cases that do not involve a codebook group (CBG) or multiple transport blocks per PDSCH, executing the “if” condition in the pseudocode may result in a single HARQ-ACK bit per slot per CC for a codebook or for a sub-codebook.

In the pseudocode listed above, when the “if” condition is not true (i.e., when the “else” condition applies), the UE may perform TDRA grouping to find a maximum number of non-overlapping SLIVs in a slot (for each slot within the slots determined by the set of slot offset values K1) in a CC. The UE may then add one candidate PDSCH occasion to a set of PDSCH occasions per slot for each TDRA group/non-overlapping SLIV. This may result in multiple HARQ-ACK bits per slot per CC for a codebook or for a sub-codebook.

When the “else” condition in the pseudocode applies, a type 1 HARQ-ACK codebook may accommodate a number of bits equal to a number of potential PDSCH reception occasions. In an example, if TDRA (i.e., a configured table) includes SLIVs for symbols {0, 1}, {2, 3}, {4, 5} . . . {12, 13}, there may be seven bits per K1 value per component carrier (CC). In another example, if K1={1, 2, 3}, there may be 7*3=21 bits per CC for FDD (or less than 21 bits for TDD based on a number of SLIVs that overlap with U symbols).

When the “if” condition in the pseudocode applies (i.e., when the UE does not indicate a capability to receive more than one PDSCH per slot), there may be 1 bit per slot (or per K1 value) for the type 1 HARQ-ACK codebook. Thus, when the “if” condition applies, the UE may not perform TDRA grouping, and a codebook size may be independent of a maximum number of non-overlapping SLIVs corresponding to different TDRA rows. Otherwise, a capability of a UE with respect to a maximum number of PDSCHs per slot is not considered (the maximum number of non-overlapping SLIVs in TDRA may be considered).

The pseudocode listed above may be associated with various issues. First, there may be ambiguity with respect to “capability to receive more than one unicast PDSCH per slot,” as it may be unclear as to which UE capability is associated with “capability to receive more than one unicast PDSCH per slot.” Second, there may be ambiguity with respect to “capability to receive more than one unicast PDSCH per slot,” as it may be unclear as to which CC/band in a carrier aggregation configuration has the “capability to receive more than one unicast PDSCH per slot.” Third, a network (e.g., a base station) may not have the ability to enable/disable the capability of receiving more than one PDSCH per slot. Thus, the UE may still generate a type 1 HARQ-ACK codebook based on the capability of receiving more than one PDSCH per slot regardless of whether the network intends to utilize the aforementioned capability, which may lead to a relatively large type 1 HARQ-ACK codebook. This may lead to an inefficient usage of resources at the UE without a corresponding benefit when the network does not utilize the aforementioned capability.

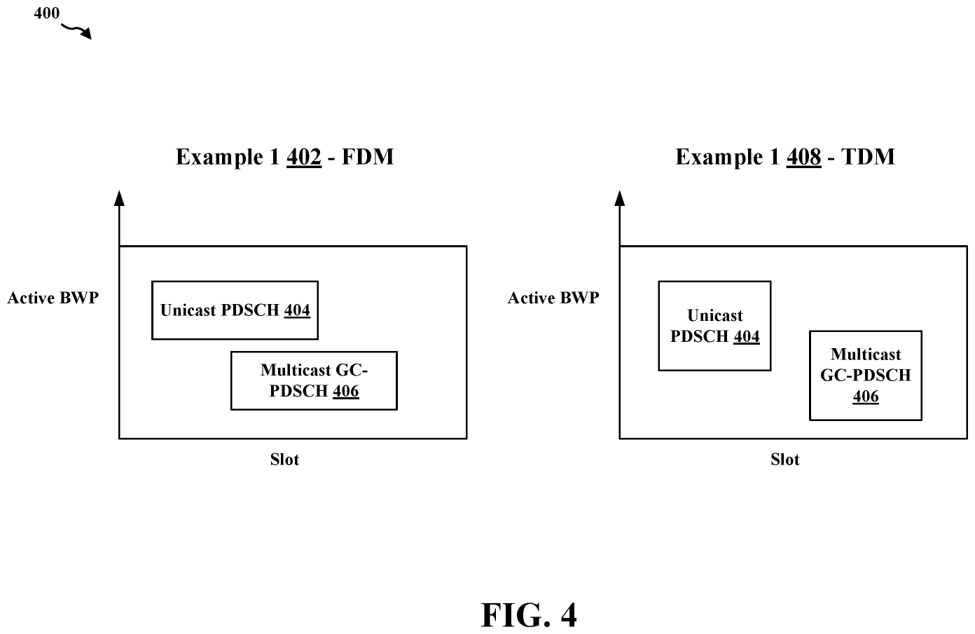

FIG. 4 is a diagram 400 illustrating examples of FDM and TDM for unicast and multicast. Multiplexing may refer to consolidating multiple signals into a composite signal that is transported over a common medium. Multiplexing may include FDM and TDM (explained in greater detail below). UEs that are RRC connected (i.e., RRC_Connected) may undergo multicast group scheduling. A unicast PDSCH may refer to a PDSCH that is transmitted for a specific UE. A multicast PDSCH may refer to a PDSCH that is transmitted for a group of UEs. A multicast PDSCH may alternatively be referred to as a group common (GC) PDSCH (GC-PDSCH) or as a multicast GC-PDSCH. Furthermore, unicast PDSCH(s) and/or multicast PDSCH(s) may be multiplexed using FDM or TDM. With respect to unicast PDSCH(s) and/or multicast PDSCH(s), FDM may refer to transmitting unicast PDSCH(s) and/or multicast PDSCH(s) such that the unicast PDSCH(s) and/or multicast PDSCH(s) at least partially overlap in a time domain and such that the unicast PDSCH(s) and/or multicast PDSCH(s) are separated in a frequency domain. With respect to unicast PDSCH(s) and/or multicast PDSCH(s), TDM may refer to transmitting unicast PDSCH(s) and/or multicast PDSCH(s) such that the unicast PDSCH(s) and/or multicast PDSCH(s) are separated in a time domain (i.e., the unicast PDSCH(s) and/or the multicast PDSCH(s) do not overlap in time).

Inter-slot TDM (i.e., between slots) may be performed between multicast and unicast for a UE that is configured for multicast. Intra-slot TDM (i.e., within the same slot) and/or intra-slot FDM (i.e., within the same slot) may be performed between multicast and unicast based on UE capabilities. Intra-slot TDM/intra-slot FDM may support simultaneous reception of unicast PDSCH(s) and GC-PDSCH(s) in a slot. In a first example with respect to intra-slot FDM between multicast and unicast, one unicast PDSCH and one GC-PDSCH may be frequency division multiplexed (FDMed) in a slot. In a second example with respect to intra-slot TDM between multicast and unicast, one or multiple unicast PDSCHs and one or more multiple multicast GC-PDSCHs may be time division multiplex (TDMed) in a slot. In a third example with respect to intra-slot TDM between multicast and unicast, multiple multicast GC-PDSCHs may be TDMed in a slot per a CC. A maximum number of TDMed PDSCH receptions that may be received in a slot per a CC may be 2, 4, or 7.

In a first example 402, a unicast PDSCH 404 and a multicast GC-PDSCH 406 may be FDMed. For instance, the unicast PDSCH 404 and the multicast GC-PDSCH 406 may at least partially overlap in a time domain (i.e., at least partially overlap in a slot) and the unicast PDSCH 404 and the multicast GC-PDSCH 406 may be separated in a frequency domain (i.e., separated within an active bandwidth part (BWP)). In a second example 408, the unicast PDSCH 404 and the multicast GC-PDSCH 406 may be separated in the time domain (i.e., separated within a slot).

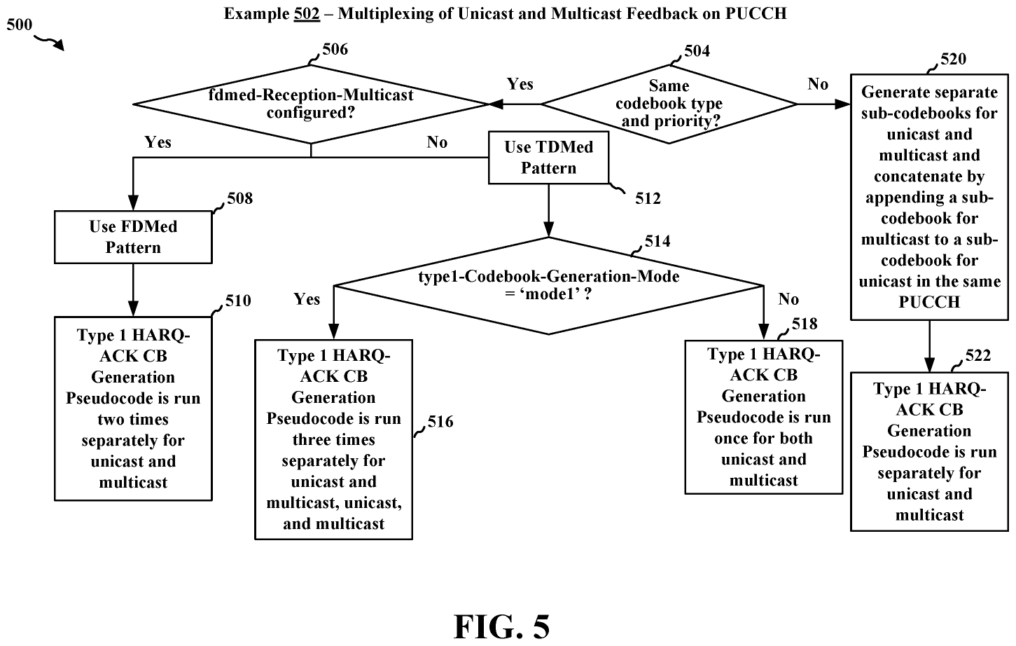

FIG. 5 is a diagram 500 illustrating an example 502 of multiplexing unicast and multicast feedback on a PUCCH. Multiplexing unicast and multicast HARQ-ACK feedback on a PUCCH may be based on a codebook type for unicast and/or multicast, a codebook priority for unicast and/or multicast, a type of codebook generation mode, and/or whether or not a UE is configured for FDM reception multicast (i.e., whether fdmed-Reception-Multicast is configured for the UE).

At 504, a UE may determine a codebook type and a priority of unicast and multicast HARQ-ACK feedback. If both the codebook type and the priority (e.g., low, high, etc.) of the unicast and multicast HARQ-ACK feedback are the same, at 506, the UE may determine whether the UE is configured for FDM reception multicast (i.e., whether fdmed-Reception-Multicast is configured for the UE).

If fdmed-Reception-Multicast is configured for the UE, at 508, the UE may use a FDMed pattern for multiplexing the unicast and the multicast HARQ-ACK feedback. For instance, when the FDMed pattern is used, HARQ-ACK bits for all PDSCH occasions over all slots for all serving cells for unicast may precede HARQ-ACK bits for all PDSCH occasions over all slots for all serving cells for multicast group radio network temporary identifier(s) (G-RNTI(s)). As a result, at 510, the pseudocode listed above (i.e., “the type 1 HARQ-ACK codebook generation pseudocode”) may be run separately for unicast and multicast. For example, the pseudocode listed above may be run two times separately for unicast and multicast.

If fdmed-Reception-Multicast is not configured for the UE, at 512, the UE may use a TDMed pattern for multiplexing the unicast and multicast HARQ-ACK feedback. At 514, the UE may determine whether a type 1 codebook generation mode is mode 1 (i.e., whether type 1-Codebook-Generation-Mode ‘model’). If type1-Codebook-Generation-Mode ‘mode 1,’ at 516, the UE may determine PDSCH reception candidate occasions: (1) based on a union of PDSCH TDRA sets for slot timing values K1 in an intersection of a unicast K1 set and a multicast K1 set, (2) based on a PDSCH TDRA set for unicast for slot timing values in the unicast K1 set, but not in the multicast K1 set, and (3) based on a PDSCH TDRA set for multicast for slot timing values K1 in the multicast K1 set, but not in the unicast K1 set. As a result, at 516, the UE may run the type 1 HARQ-ACK codebook generation pseudocode three times separately for: (1) both unicast and multicast (in slots in which both unicast and multicast may be scheduled), (2) unicast (in slots in which unicast may be scheduled), and (3) multicast (in slots in which multicast may be scheduled). If type1-Codebook-Generation-Mode≠‘mode1’ (e.g., the codebook generation mode is mode 2), PDSCH reception candidate occasions may be based on a union of unicast and multicast PDSCH TDRA sets and a K1 set (e.g., a union of a unicast K1 set and a multicast K1 set). As a result, at 518, the UE may run the type 1 HARQ-ACK codebook generation pseudocode one time for both unicast and multicast (i.e., a single instance of running the type 1 HARQ-ACK codebook generation pseudocode).

If (1) the codebook type of the unicast and multicast HARQ-ACK feedback is the same and the priority is different or (2) if the codebook type of the unicast and multicast HARQ-ACK feedback is different and the priority is the same, at 520, the UE may generate separate sub-codebooks for unicast and multicast and concatenate the separate sub-codebooks by appending a sub-codebook for multicast to a sub-codebook for unicast in a same PUCCH. As a result, at 522, the UE may run the type 1 HARQ-ACK codebook generation pseudocode separately for unicast and multicast (if a corresponding codebook type is configured as type 1).

A UE may be configured with the ability to receive one PDSCH per slot or the UE may be configured with the ability to receive more than one PDSCH per slot, where the aforementioned PDSCHs may be or include unicast PDSCHs(s) or multicast PDSCH(s). A manner in which a UE generates a type 1 HARQ-ACK codebook may be affected by whether or not the UE is configured with the ability to receive more than one PDSCH per slot, codebook types associated with multiplexing unicast and multicast HARQ-ACK feedback, priorities associated with codebook types, whether FDM or TDM is used for multiplexing, and/or a type of codebook generation mode. Furthermore, different manners of generating type 1 HARQ-ACK codebooks may result in different sizes for the type 1 HARQ-ACK codebooks. However, a network node may not be able to enable or disable the ability of the UE to receive more than one PDSCH per slot. In an example, a UE that is capable of receiving more than one PDSCH per slot may generate a type 1 HARQ-ACK codebook in a first manner, but the network may not support the capability of the UE receiving more than one PDSCH per slot. As a result, the type 1 HARQ-ACK codebook may have a size that is greater than a size of a type 1 HARQ-ACK codebook that would result had the UE generated the type 1 HARQ-ACK codebook in a second manner associated with the network not supporting the capability of the UE of receiving more than one PDSCH per slot.

Various technologies pertaining to an impact of more than one PDSCH per slot on a HARQ-ACK codebook for multicast are described herein. In an example, a UE receives RRC signaling indicating whether more than one PDSCH is configured for at least one slot associated with at least one HARQ-ACK codebook. The UE performs, for the at least one HARQ-ACK codebook for multiplexing feedback between unicast and multicast for HARQ-ACK, one of: an addition of a candidate PDSCH occasion to a set of candidate PDSCH occasions for the at least one slot based on the RRC signaling; or TDRA grouping for the at least one slot based on the RRC signaling. Vis-à-vis performing an addition of a candidate PDSCH occasion or performing TDRA grouping based on the RRC signaling, the UE may reduce a size of the at least one HARQ-ACK codebook, thus conserving resources of the UE associated with codebook generation.

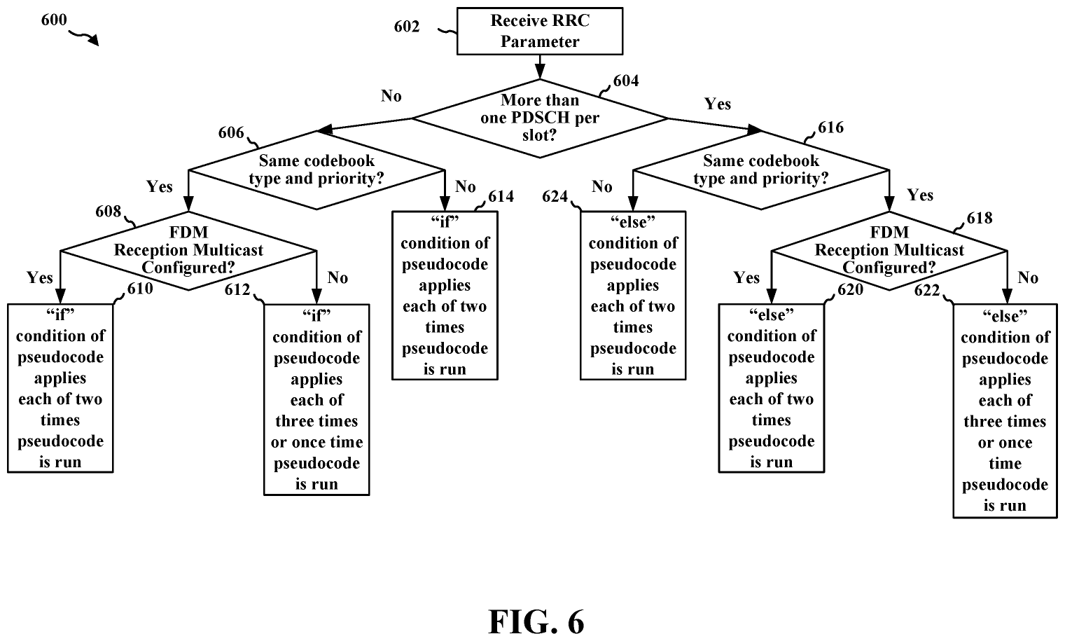

FIG. 6 is a diagram 600 illustrating an example of interpreting type 1 HARQ-ACK codebook pseudocode in the presence of HARQ-ACK for multicast. At 602, a UE may receive RRC signaling from a network node, where the RRC signaling may include a (single) RRC parameter that determines the “if”/“else” condition in the type 1 HARQ-ACK codebook pseudocode in the presence of HARQ-ACK for multicast.

At 604, if the RRC parameter is set to disabled, the UE may not be is capable of receiving more than one PDSCH per slot per CC (i.e., the “if” condition of the pseudocode applies). At 606, if the UE is not capable of receiving more than one PDSCH per slot, the UE may determine whether multiplexing of unicast and multicast HARQ-ACK feedback is associated with codebooks of the same type and the same priority. At 608, if the multiplexing of the unicast and multicast HARQ-ACK feedback is associated with codebooks of the same type and the same priority, the UE may determine whether FDM reception multicast (i.e., fdmed-Reception-Multicast) is configured for the UE.

If fdmed-Reception-Multicast is configured, the UE may be capable of receiving no more than one PDSCH per slot and no more than one multicast PDSCH per slot; however, the UE may receive more than one PDSCH per slot across both unicast and multicast. Thus, at 610, the “if” condition of the pseudocode applies each of the two times the pseudocode is run. Stated differently, at 610, the UE may perform, for unicast and for a first sub-codebook, a first addition of a first candidate PDSCH occasion to a set of candidate PDSCH occasions and the UE may perform, for multicast and for a second sub-codebook, a second addition of a second candidate PDSCH occasion to the set of candidate PDSCH occasions.

If fdmed-Reception-Multicast is not configured, the UE may be capable of receiving no more than one PDSCH per slot across both unicast and multicast. Furthermore, if fdmed-Reception-Multicast is not configured, TDM may apply. Thus, at 612, the “if” condition of the pseudocode may apply each of the three times (type1-Codebook-Generation-Mode=‘mode1’) or the one time (type1-Codebook-Generation-Mode=‘mode2’) the pseudocode is run. Stated differently, at 612 if type1-Codebook-Generation-Mode ‘mode 1,’ the UE may perform, for unicast and for a first sub-codebook, a first addition of a first candidate PDSCH occasion to a set of candidate PDSCH occasions, the UE may perform, for multicast and for a second sub-codebook, a second addition of a second candidate PDSCH occasion to the set of candidate PDSCH occasions, and the UE may perform, for unicast and multicast and for a third sub-codebook, a third addition of a third candidate PDSCH occasion to the set of candidate PDSCH occasions. Alternatively, at 612, if (type1-Codebook-Generation-Mode=‘mode 2,’ the UE may perform, for unicast and multicast, a first addition of a first candidate PDSCH occasion to the set of candidate PDSCH occasions.

If multiplexing of unicast and multicast HARQ-ACK feedback is associated with codebooks having the same codebook type and different priorities or if the multiplexing of unicast and multicast HARQ-ACK feedback is associated with codebooks having different codebook types and the same priority, at 614, the “if” condition of the pseudocode may apply each of the two times the pseudocode is run. Stated differently, at 614, the UE may perform, for unicast and for a first sub-codebook, a first addition of a first candidate PDSCH occasion to a set of candidate PDSCH occasions and the UE may perform, for multicast and for a second sub-codebook, a second addition of a second candidate PDSCH occasion to the set of candidate PDSCH occasions.

At 616, if the RRC parameter in the RRC signaling is set to enabled, the UE may be capable of receiving more than one PDSCH per slot per CC (i.e., the “else” condition of the pseudocode applies), and the UE may determine whether multiplexing of unicast and multicast HARQ-ACK feedback is associated with codebooks of the same type and the same priority. At 618, if the multiplexing of the unicast and multicast HARQ-ACK feedback is associated with codebooks of the same type and the same priority, the UE may determine whether FDM reception multicast (i.e., fdmed-Reception-Multicast) is configured for the UE.

If fdmed-Reception-Multicast is configured, the UE may be capable of receiving more than one unicast PDSCH per slot and more than one multicast PDSCH per slot. Thus, at 620, the “else” condition of the pseudocode applies each of the two times the pseudocode is run. Stated differently, at 620, the UE may perform, for unicast and for a first sub-codebook, a first TDRA grouping for a slot and the UE may perform, for multicast and for a second sub-codebook, a second TDRA grouping for the slot.

If fdmed-Reception-Multicast is not configured, the UE may be capable of receiving more than one PDSCH per slot across both unicast and multicast. Furthermore, if fdmed-Reception-Multicast is not configured, TDM may apply. Thus, at 622, the “else” condition of the pseudocode may apply each of the three times (type1-Codebook-Generation-Mode=‘mode1’) or the one time (type1-Codebook-Generation-Mode=‘mode2’) the pseudocode is run. Stated differently, at 622, if type1-Codebook-Generation-Mode=‘mode1,’ the UE may perform, for unicast and for a first sub-codebook, a first TDRA grouping for a slot, the UE may perform, for multicast and for a second sub-codebook, a second TDRA grouping for the slot, and the UE may perform, for unicast and multicast and for a third sub-codebook, a third TDRA grouping for the slot. Alternatively, at 622, if (type1-Codebook-Generation-Mode=‘mode 2,’ the UE may perform, for unicast and multicast, a first TDRA grouping for a slot.

If multiplexing of unicast and multicast HARQ-ACK feedback is associated with codebooks having the same codebook type and different priorities or if the multiplexing of unicast and multicast HARQ-ACK feedback is associated with codebooks having different codebook types and the same priority, at 624, the “else” condition of the pseudocode may apply each of the two times the pseudocode is run. Stated differently, at 624, the UE may perform, for unicast and for a first sub-codebook, a first TDRA grouping for a slot and the UE may perform, for multicast and for a second sub-codebook, a second TDRA grouping for the slot.

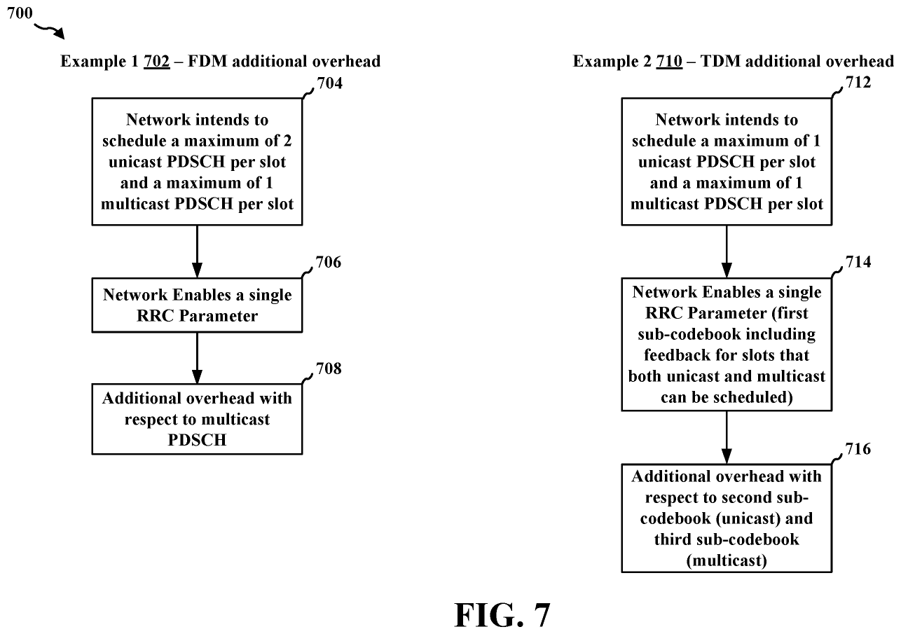

FIG. 7 is a diagram 700 illustrating example aspects of additional overhead pertaining to FDM and TDM with respect to multicast. In the example described above with respect to FIG. 6, the RRC parameter received at 602 may not be specific to multicast. However, this may lead to additional overhead in some cases.

In a first example 702 corresponding to 624 or 620 of FIG. 6, fdmed-Reception-Multicast may be configured for multiplexing unicast and multicast HARQ-ACK feedback with the same codebook type and the same priority or the UE may be configured for multiplexing unicast and multicast HARQ-ACK feedback with the same codebook type and different priorities or the UE may be configured for multiplexing unicast and multicast HARQ-ACK feedback with different codebook types and the same priority.

At 704, a network (i.e., a network node) may intend to schedule a maximum of two unicast PDSCHs per slot and a maximum of one multicast PDSCH per slot. At 706, the network may enable a single RRC parameter (e.g., the parameter received at 602). At 708, this may result in additional overhead for a multicast sub-codebook, as the “if” condition of the pseudocode (single candidate PDSCH occasion per slot) for multicast may have been suitable. Stated differently, for the multicast PDSCH, the UE may have performed an addition of a candidate PDSCH occasion to a set of candidate PDSCH occasions (smaller codebook size) instead of performing TDRA grouping (larger codebook size). Similarly, if the network intends to schedule a maximum of two multicast PDSCHs and a maximum of one unicast PDSCH per slot, this may also result in additional overhead (in this case, additional overhead for the unicast sub-codebook).

In a second example 710 corresponding to 622 of FIG. 6, fdmed-Reception-Multicast may not be configured for multiplexing unicast and multicast HARQ-ACK feedback with the same codebook type and the same priority and type 1-Codebook-Generation-Mode=‘mode1.’ As fdmed-Reception-Multicast is not configured, the UE may perform TDM for multiplexing unicast and multicast HARQ-ACK feedback.

At 712, a network (i.e., a network node) may intend to schedule a maximum of one unicast PDSCH per slot and a maximum of one multicast PDSCH per slot. At 714, the network may enable a single RRC parameter (e.g., the parameter received at 602) due to the possibility of the UE being able to receive more than one PDSCH per slot overall as a result of a first sub-codebook (unicast and multicast) including feedback for slots in which both unicast and multicast can be scheduled. At 716, this may result in additional overhead for a second sub-codebook (unicast) and a third sub-codebook (multicast), as the “if” condition of the pseudocode (single candidate PDSCH occasion per slot) may have been suitable. Stated differently, for the unicast PDSCH associated with the second sub-codebook, the UE may have performed an addition of a candidate PDSCH occasion to a set of candidate PDSCH occasions (smaller codebook size) instead of performing TDRA grouping (larger codebook size). Similarly, for the multicast PDSCH associated with the third sub-codebook, the UE may have performed an addition of a candidate PDSCH occasion to a set of candidate PDSCH occasions (smaller codebook size) instead of performing TDRA grouping (larger codebook size).

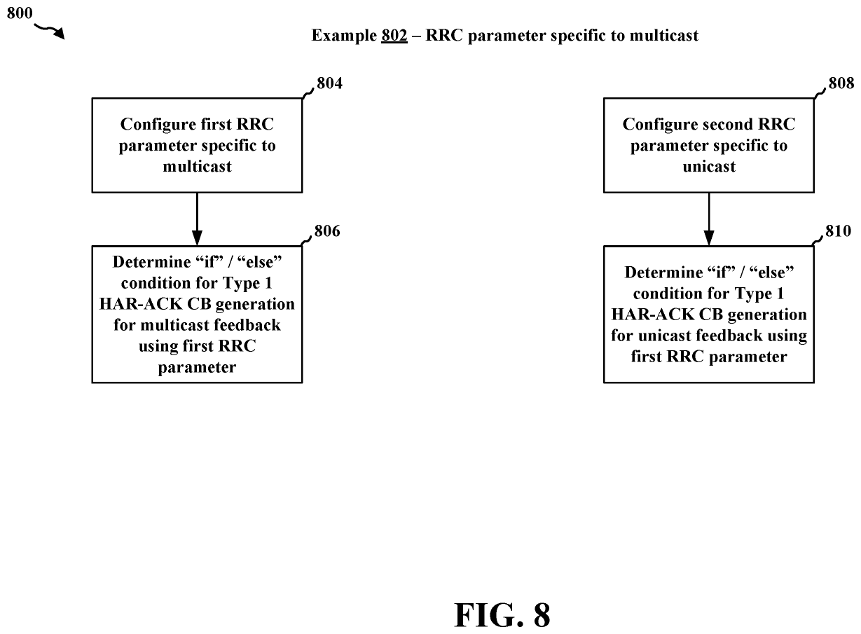

FIG. 8 is a diagram 800 illustrating an example 802 of aspects pertaining to RRC parameters. At 804, a network may configure a first RRC parameter specific to multicast. The first RRC parameter may indicate no possibility (e.g., when a value of the first RRC parameter is set to “disabled”) of receiving more than one multicast PDSCH per slot or a possibility (e.g., when the value of the first RRC parameter is set to “enabled”) of receiving more than one multicast PDSCH per slot. The network may transmit the first RRC parameter in RRC signaling and the UE may receive the RRC signaling. At 806, the UE may utilize the first RRC parameter to determine whether the “if”/“else” condition applies in the type 1 HARQ-ACK codebook generation pseudocode for multicast feedback. For instance, if the value of the first RRC parameter is set to disabled, the UE may perform, for multicast, an addition of a candidate PDSCH occasion to a set of candidate PDSCH occasions, and if the value of the first RRC parameter is set to enabled, the UE may perform, for multicast, TDRA grouping.

At 808, the network may configure a second RRC parameter specific to unicast. In an example, the second RRC parameter may be or include the RRC parameter received at 602 in FIG. 6. The second RRC parameter may indicate no possibility (e.g., when a value of the second RRC parameter is set to “disabled”) of receiving more than one unicast PDSCH per slot or a possibility (e.g., when the value of the second RRC parameter is set to “enabled”) of receiving more than one unicast PDSCH per slot. The network may transmit the second RRC parameter in RRC signaling and the UE may receive the RRC signaling. At 810, the UE may utilize the second RRC parameter to determine whether the “if”/“else” condition applies in the type 1 HARQ-ACK codebook generation pseudocode for unicast feedback. For instance, if the value of the second RRC parameter is set to disabled, the UE may perform, for unicast, an addition of a candidate PDSCH occasion to a set of candidate PDSCH occasions, and if the value of the second RRC parameter is set to enabled, the UE may perform, for unicast, TDRA grouping.

The example 802 may be useful in scenarios in which fdmed-Reception-Multicast is configured for multiplexing unicast and multicast HARQ-ACK feedback with the same codebook type and the same priority, for multiplexing unicast and multicast HARQ-ACK feedback with the same codebook type and different priorities, or for multiplexing unicast and multicast HARQ-ACK feedback with different codebook types and the same priority. The aforementioned scenarios may correspond to the first example 702 of FIG. 7.

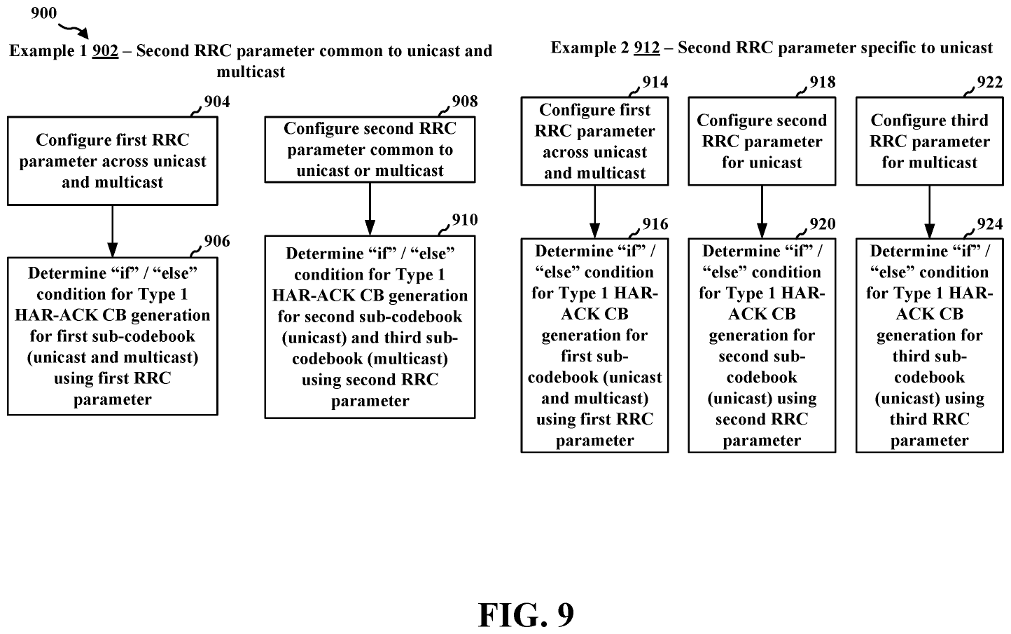

FIG. 9 is a diagram 900 illustrating another example of aspects pertaining to RRC parameters. In some aspects, a network (i.e., a network node) may configure at least two RRC parameters. In an example, a first RRC parameter may indicate no possibility (e.g., when a value of the first RRC parameter is set to “disabled”) or a possibility (e.g., when a value of the first RRC parameter is set to “enabled”) of receiving more than one PDSCH per slot across both unicast and multicast. The second RRC parameter may indicate no possibility (e.g., when a value of the second RRC parameter is set to “disabled”) or a possibility (e.g., when a value of the second RRC parameter is set to “enabled”) of receiving more than one PDSCH per slot for unicast or for multicast.

In a first example 902, at 904, the network may configure a first RRC parameter across unicast and multicast. The network may transmit the first RRC parameter to the UE in RRC signaling and the UE may receive the RRC signaling. At 906, the UE may determine the “if”/“else” condition of the type 1 HARQ-ACK codebook generation pseudocode for a first sub-codebook for both unicast and multicast in slots in which both unicast and multicast can be scheduled using the first RRC parameter. For instance, if the value of the first RRC parameter is set to disabled, the UE may perform, for unicast and multicast, an addition of a candidate PDSCH occasion to a set of candidate PDSCH occasions, and if the value of the first RRC parameter is set to enabled, the UE may perform, for unicast and multicast, TDRA grouping.

In the first example 902, at 908, the network may configure a second RRC parameter common to unicast or multicast. The network may transmit the second RRC parameter to the UE in the RRC signaling (or different RRC signaling) and the UE may receive the RRC signaling (or the different RRC signaling). At 910, the UE may determine the “if”/“else” condition of the type 1 HARQ-ACK codebook generation pseudocode for a second sub-codebook for unicast in slots in which unicast can be scheduled using the second RRC parameter and the UE may determine the “if”/“else” condition of the type 1 HARQ-ACK codebook generation pseudocode for a third sub-codebook for multicast in slots in which multicast can be scheduled using the second RRC parameter.

In a second example 912, at 914, the network may configure a first RRC parameter across unicast and multicast. The network may transmit the first RRC parameter to the UE in RRC signaling and the UE may receive the RRC signaling. At 916, the UE may determine the “if”/“else” condition of the type 1 HARQ-ACK codebook generation pseudocode for a first sub-codebook for both unicast and multicast in slots in which both unicast and multicast can be scheduled using the first RRC parameter. For instance, if the value of the first RRC parameter is set to disabled, the UE may perform, for unicast and multicast, an addition of a candidate PDSCH occasion to a set of candidate PDSCH occasions, and if the value of the first RRC parameter is set to enabled, the UE may perform, for unicast and multicast, TDRA grouping.

In the second example 912, at 918, the network may configure a second RRC parameter for unicast. The network may transmit the second RRC parameter to the UE in the RRC signaling (or different RRC signaling) and the UE may receive the RRC signaling (or the different RRC signaling). At 920, the UE may determine the “if”/“else” condition of the type 1 HARQ-ACK codebook generation pseudocode for a second sub-codebook for unicast in slots in which unicast can be scheduled using the second RRC parameter.

In the second example 912, at 922, the network may configure a third RRC parameter for multicast. The network may transmit the third RRC parameter to the UE in the RRC signaling (or different RRC signaling) and the UE may receive the RRC signaling (or the different RRC signaling). At 924, the UE may determine the “if”/“else” condition of the type 1 HARQ-ACK codebook generation pseudocode for a third sub-codebook for multicast in slots in which multicast can be scheduled using the third RRC parameter.

The first example 902 and/or the second example 912 may be useful in a scenario in which fdmed-Reception-Multicast is not configured for multiplexing unicast and multicast HARQ-ACK feedback with the same codebook type and the same priority and when type1-Codebook-Generation-Mode=‘mode1’. The aforementioned scenario may correspond to the second example 710 of FIG. 7.

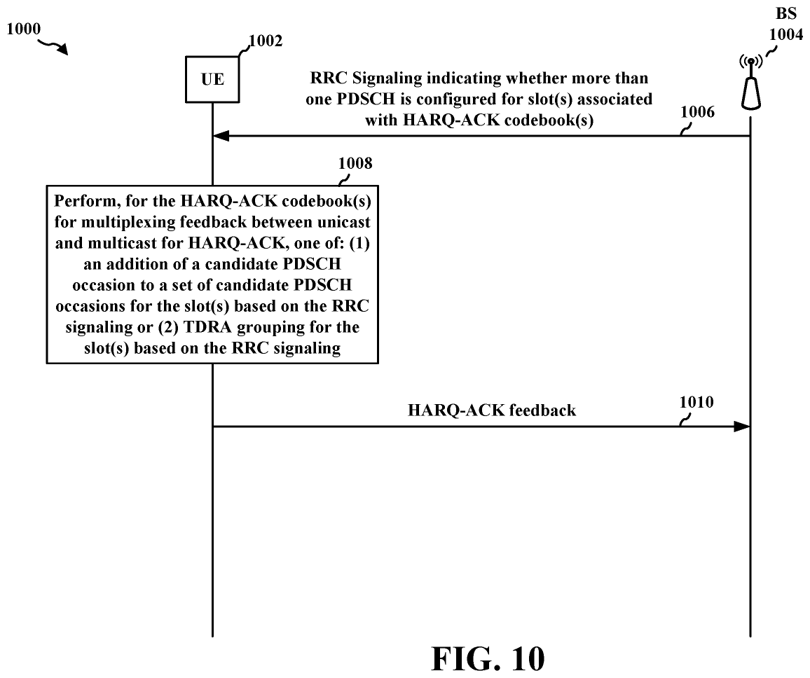

FIG. 10 is a diagram 1000 illustrating example communications between a UE 1002 and a base station 1004. At 1006, the UE 1002 may receive, from the base station 1004, RRC signaling indicating whether more than one PDSCH is configured for at least one slot associated with at least one HARQ-ACK codebook. At 1008, the UE 1002 may perform, for the at least one HARQ-ACK codebook for multiplexing feedback between unicast and multicast for HARQ-ACK, one of: (1) an addition of a candidate PDSCH occasion to a set of candidate PDSCH occasions for the at least one slot based on the RRC signaling or TDRA grouping for the at least one slot based on the RRC signaling. At 1010, the UE may transmit HARQ-ACK feedback to the base station 1004, where the HARQ-ACK feedback may be multiplexed between unicast and multicast based on whether the UE performed one of the addition of the candidate PDSCH occasion to the set of candidate PDSCH occasions or the TDRA grouping.

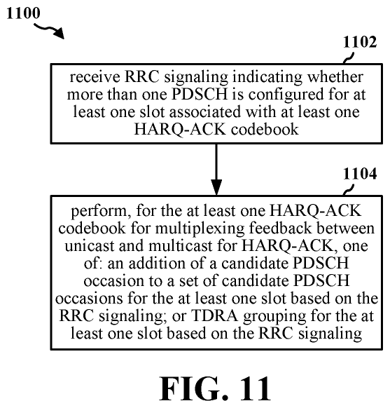

FIG. 11 is a flowchart 1100 of a method of wireless communication. The method may be performed by a UE (e.g., the UE 104, the UE 350, the UE 1002, the apparatus 1504). In an example, the method may be performed by the HARQ-ACK CB component 198.

At 1102, the UE receives RRC signaling indicating whether more than one PDSCH is configured for at least one slot associated with at least one HARQ-ACK codebook. For example, FIG. 10 at 1006 shows that the UE 1002 may receive RRC signaling indicating whether more than one PDSCH is configured for at least one slot associated with at least one HARQ-ACK codebook. In an example, 1102 may be performed by the HARQ-ACK CB component 198.

At 1104, the UE performs, for the at least one HARQ-ACK codebook for multiplexing feedback between unicast and multicast for HARQ-ACK, one of: an addition of a candidate PDSCH occasion to a set of candidate PDSCH occasions for the at least one slot based on the RRC signaling or TDRA grouping for the at least one slot based on the RRC signaling. For example, FIG. 10 at 1008 shows that the UE 1002 may perform for the at least one HARQ-ACK codebook for multiplexing feedback between unicast and multicast for HARQ-ACK, one of: an addition of a candidate PDSCH occasion to a set of candidate PDSCH occasions for the at least one slot based on the RRC signaling or TDRA grouping for the at least one slot based on the RRC signaling. In an example, 1104 may be performed by the HARQ-ACK CB component 198.

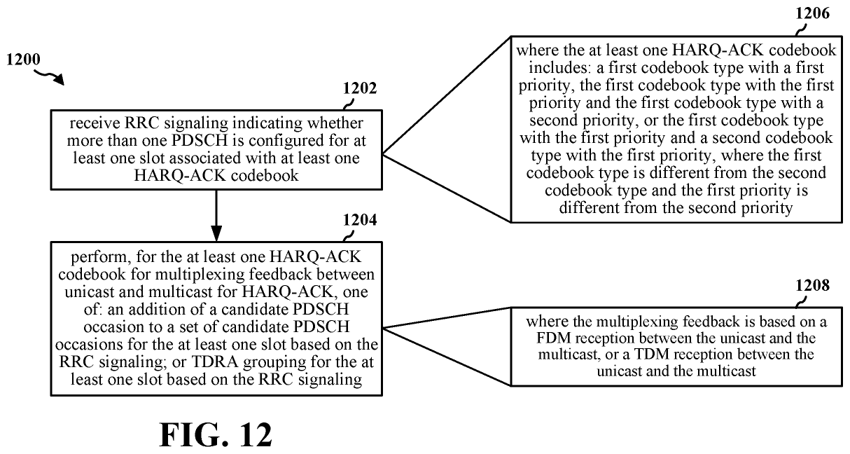

FIG. 12 is a flowchart 1200 of a method of wireless communication. The method may be performed by a UE (e.g., the UE 104, the UE 350, the UE 1002, the apparatus 1504). In an example, the method (including the various aspects detailed below) may be performed by the HARQ-ACK CB component 198.

At 1202, the UE receives RRC signaling indicating whether more than one PDSCH is configured for at least one slot associated with at least one HARQ-ACK codebook. For example, FIG. 10 at 1006 shows that the UE 1002 may receive RRC signaling indicating whether more than one PDSCH is configured for at least one slot associated with at least one HARQ-ACK codebook. In an example, 1202 may be performed by the HARQ-ACK CB component 198.

At 1204, the UE performs, for the at least one HARQ-ACK codebook for multiplexing feedback between unicast and multicast for HARQ-ACK, one of: an addition of a candidate PDSCH occasion to a set of candidate PDSCH occasions for the at least one slot based on the RRC signaling or TDRA grouping for the at least one slot based on the RRC signaling. For example, FIG. 10 at 1008 shows that the UE 1002 may perform for the at least one HARQ-ACK codebook for multiplexing feedback between unicast and multicast for HARQ-ACK, one of: an addition of a candidate PDSCH occasion to a set of candidate PDSCH occasions for the at least one slot based on the RRC signaling or TDRA grouping for the at least one slot based on the RRC signaling. In an example, 1204 may be performed by the HARQ-ACK CB component 198.

In one aspect, at 1206, the at least one HARQ-ACK codebook may include: a first codebook type with a first priority, the first codebook type with the first priority and the first codebook type with a second priority, or the first codebook type with the first priority and a second codebook type with the first priority, where the first codebook type may be different from the second codebook type and the first priority is different from the second priority. For example, the at least one HARQ-ACK codebook of FIG. 10 may include a first codebook type with a first priority, the first codebook type with the first priority and the first codebook type with a second priority, or the first codebook type with the first priority and a second codebook type with the first priority, where the first codebook type may be different from the second codebook type and the first priority is different from the second priority.

In one aspect, at 1208, the multiplexing feedback may be based on a FDM reception between the unicast and the multicast, or a TDM reception between the unicast and the multicast. For example, the FDM reception between the unicast and the multicast, or the TDM reception between the unicast and the multicast may include aspects described above in the description of FIG. 4.

In one aspect, the RRC signaling may indicate that the more than one PDSCH is not configured for the at least one slot, where the addition of the candidate PDSCH occasion to the set of candidate PDSCH occasions may be performed based on the UE being configured for the FDM reception between the unicast and the multicast, and where performing the addition of the candidate PDSCH occasion to the set of candidate PDSCH occasions may include: performing, for the unicast, a first addition of a first candidate PDSCH occasion to the set of candidate PDSCH occasions; and performing, for the multicast, a second addition of a second candidate PDSCH occasion to the set of candidate PDSCH occasions. For example, the aforementioned aspect may correspond to 610 of FIG. 6.

In one aspect, the RRC signaling may indicate that the more than one PDSCH is not configured for the at least one slot, where the at least one HARQ-ACK codebook may include a first codebook type with a first priority and the first codebook type with a second priority or the at least one HARQ-ACK codebook may include the first codebook type with the first priority and a second codebook type with the first priority, where performing the addition of the candidate PDSCH occasion to the set of candidate PDSCH occasions may include: performing, for the unicast, a first addition of a first candidate PDSCH occasion to the set of candidate PDSCH occasions; and performing, for the multicast, a second addition of a second candidate PDSCH occasion to the set of candidate PDSCH occasions. For example, the aforementioned aspect may correspond to 614 of FIG. 6.

In one aspect, the RRC signaling may indicate that the more than one PDSCH is configured for the at least one slot, where the TDRA grouping may be performed based on the UE being configured for the FDM reception between the unicast and the multicast, and where performing the TDRA grouping for the at least one slot may include: performing, for the unicast, a first TDRA grouping for the at least one slot; and performing, for the multicast, a second TDRA grouping for the at least one slot. For example, the aforementioned aspect may correspond to 620 of FIG. 6.

In one aspect, the RRC signaling may indicate that the more than one PDSCH is configured for the at least one slot, where the at least one HARQ-ACK codebook may include a first codebook type with a first priority and the first codebook type with a second priority or the at least one HARQ-ACK codebook may include the first codebook type with the first priority and a second codebook type with the first priority, and where performing the TDRA grouping for the at least one slot may include: performing, for the unicast, a first TDRA grouping for the at least one slot; and performing, for the multicast, a second TDRA grouping for the at least one slot. For example, the aforementioned aspect may correspond to 624 of FIG. 6.

In one aspect, the at least one HARQ-ACK codebook may be associated with a mode 1 codebook generation mode or a mode 2 codebook generation mode. For example, the at least one HARQ-ACK codebook of FIG. 10 may be associated with a mode 1 codebook generation mode or a mode 2 codebook generation mode.

In one aspect, the RRC signaling may indicate that the more than one PDSCH is not configured for the at least one slot, where the at least one HARQ-ACK codebook may be associated with a mode 1 codebook generation mode, where the addition of the candidate PDSCH occasion to the set of candidate PDSCH occasions may be performed based on the UE not being configured for the FDM reception between the unicast and the multicast, and where performing the addition of the candidate PDSCH occasion to the set of candidate PDSCH occasions may include: performing, for the unicast, a first addition of a first candidate PDSCH occasion to the set of candidate PDSCH occasions; performing, for the multicast, a second addition of a second candidate PDSCH occasion to the set of candidate PDSCH occasions; and performing, for the unicast and the multicast, a third addition of a third candidate PDSCH occasion to the set of candidate PDSCH occasions. For example, the aforementioned aspect may correspond to 612 of FIG. 6.

In one aspect, the RRC signaling may indicate that the more than one PDSCH is not configured for the at least one slot, where the at least one HARQ-ACK codebook may include a first codebook type with a first priority, where the at least one HARQ-ACK codebook may be associated with a mode 2 codebook generation mode, where the addition of the candidate PDSCH occasion to the set of candidate PDSCH occasions may be performed based on the UE not being configured for the FDM reception between the unicast and the multicast, and where performing the addition of the candidate PDSCH occasion to the set of candidate PDSCH occasions may include: performing, for the unicast and the multicast, a first addition of a first candidate PDSCH occasion to the set of candidate PDSCH occasions. For example, the aforementioned aspect may correspond to 612 of FIG. 6.

In one aspect, the RRC signaling may indicate that the more than one PDSCH is configured for the at least one slot, where the at least one HARQ-ACK codebook may include a first codebook type with a first priority, where the at least one HARQ-ACK codebook may be associated with a mode 1 codebook generation mode, where the TDRA grouping may be performed based on the UE not being configured for the FDM reception between the unicast and the multicast, and where performing the TDRA grouping for the at least one slot may include: performing, for the unicast, a first TDRA grouping for the at least one slot; performing, for the multicast, a second TDRA grouping for the at least one slot; and performing, for the unicast and the multicast, a third TDRA grouping for the at least one slot. For example, the aforementioned aspect may correspond to 622 of FIG. 6.

In one aspect, the RRC signaling indicates that the more than one PDSCH may be configured for the at least one slot, where the at least one HARQ-ACK codebook may include a first codebook type with a first priority, where the at least one HARQ-ACK codebook may be associated with a mode 2 codebook generation mode, where the TDRA grouping may be performed based on the UE not being configured for the FDM reception between the unicast and the multicast, and where performing the TDRA grouping for the at least one slot may include: performing, for the unicast and the multicast, a first TDRA grouping for the at least one slot. For example, the aforementioned aspect may correspond to 622 of FIG. 6.

In one aspect, the RRC signaling may include a first RRC parameter for the unicast and a second RRC parameter for the multicast, where the first RRC parameter for the unicast may indicate whether more than unicast PDSCH is able to be received for the at least one slot, where the second RRC parameter for the multicast may indicate whether more than one multicast PDSCH is able to be received for the at least one slot, and where performing one of the addition of the candidate PDSCH occasion to the set of candidate PDSCH occasions or the TDRA grouping for the at least one slot may be based on at least one of the first RRC parameter or the second RRC parameter. For example, the aforementioned aspect may correspond to the example 802 of FIG. 8, where the first RRC parameter of FIG. 8 may be the second RRC parameter above and where the second RRC parameter of FIG. 8 may be the first RRC parameter above.

In one aspect, the first RRC parameter may be associated with a unicast HARQ-ACK sub-codebook, and where the second RRC parameter may be associated with a multicast HARQ-ACK sub-codebook. For example, the second RRC parameter in FIG. 8 may be associated with a unicast HARQ-ACK sub-codebook and the first RRC parameter in FIG. 8 may be associated with a multicast HARQ-ACK sub-codebook.

In one aspect, the RRC signaling may include a first RRC parameter and at least one second RRC parameter, where the first RRC parameter may indicate whether the more than one PDSCH is able to be received for the at least one slot across the unicast and the multicast, where the at least one second RRC parameter may indicate whether the more than one PDSCH is able to be received for the at least one slot for the unicast or for the multicast, and where performing one of the addition of the candidate PDSCH occasion to the set of candidate PDSCH occasions or the TDRA grouping for the at least one slot may be based on at least one of the first RRC parameter or the at least one second RRC parameter. For example, the aforementioned aspect may correspond to the first example 902 and/or the second example 912 of FIG. 9.

In one aspect, the addition of the candidate PDSCH occasion to the set of candidate PDSCH occasions or the TDRA grouping for the at least one slot may be associated with a first sub-codebook of the at least one HARQ-ACK codebook, where the first sub-codebook may be for the unicast and the multicast, and where performing one of the addition of the candidate PDSCH occasion to the set of candidate PDSCH occasions or the TDRA grouping for the at least one slot may be based on the first RRC parameter. For example, the aforementioned aspect may correspond to the first example 902 of FIG. 9.

In one aspect, the at least one second RRC parameter may include a second RRC parameter that indicates that the more than one PDSCH is able to be received for the at least one slot for the unicast or for the multicast, where the addition of the candidate PDSCH occasion to the set of candidate PDSCH occasions or the TDRA grouping for the at least one slot may be associated with a second sub-codebook and a third sub-codebook of the at least one HARQ-ACK codebook, where the second sub-codebook may be for the unicast and the third sub-codebook may be for the multicast, and where performing one of the addition of the candidate PDSCH occasion to the set of candidate PDSCH occasions or the TDRA grouping for the at least one slot may be based on the second RRC parameter. For example, the aforementioned aspect may correspond to the first example 902 of FIG. 9.

In one aspect, the at least one second RRC parameter may include a second RRC parameter that indicates that the more than one PDSCH is able to be received for the at least one slot for the unicast and a third RRC parameter that indicates that the more than one PDSCH is able to be received for the at least one slot for the multicast, where the addition of the candidate PDSCH occasion to the set of candidate PDSCH occasions or the TDRA grouping for the at least one slot may be associated with a second sub-codebook and a third sub-codebook of the at least one HARQ-ACK codebook, where the second sub-codebook may be for the unicast and the third sub-codebook may be for the multicast, and where performing one of the addition of the candidate PDSCH occasion to the set of candidate PDSCH occasions or the TDRA grouping for the at least one slot may be based on the second RRC parameter and the third RRC parameter. For example, the aforementioned aspect may correspond to the second example 912 of FIG. 9.

In one aspect, the RRC signaling indicating whether the more than one PDSCH is configured for the at least one slot associated with the at least one HARQ-ACK codebook may indicate whether the more than one PDSCH is configured for the at least one slot on a per component carrier basis. For example, the RRC signaling received by the UE 1002 at 1006 may indicate whether more than one PDSCH is configured for the at least one slot on a per component carrier basis.

In one aspect, the at least one HARQ-ACK codebook may be a type 1 HARQ-ACK codebook. For example, the at least one HARQ-ACK codebook of FIG. 10 may be a type 1 HARQ-ACK codebook.

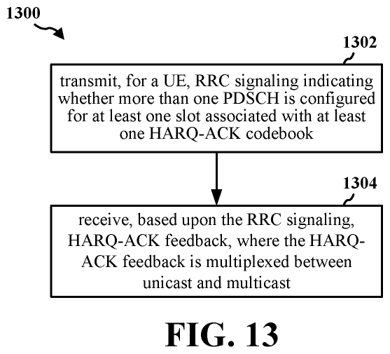

FIG. 13 is a flowchart 1300 of a method of wireless communication. The method may be performed by a network node (e.g., the base station 102, the base station 310, the base station 1004, the network entity 1502, the network entity 1602). In an example, the method may be performed by the HARQ-ACK CB component 199.

At 1302, the network node transmits, for a UE, RRC signaling indicating whether more than one PDSCH is configured for at least one slot associated with at least one HARQ-ACK codebook. For example, FIG. 10 at 1006 shows that the base station 1004 may transmit RRC signaling indicating whether more than one PDSCH is configured for at least one slot associated with at least one HARQ-ACK codebook. In an example, 1302 may be performed by the HARQ-ACK CB component 199.

At 1304, the network node receives, based upon the RRC signaling, HARQ-ACK feedback, where the HARQ-ACK feedback is multiplexed between unicast and multicast. For example, FIG. 10 at 1010 shows that the base station 1004 may receive, based upon the RRC signaling, HARQ-ACK feedback, where the HARQ-ACK feedback is multiplexed between unicast and multicast. In an example, 1304 may be performed by the HARQ-ACK CB component 199.

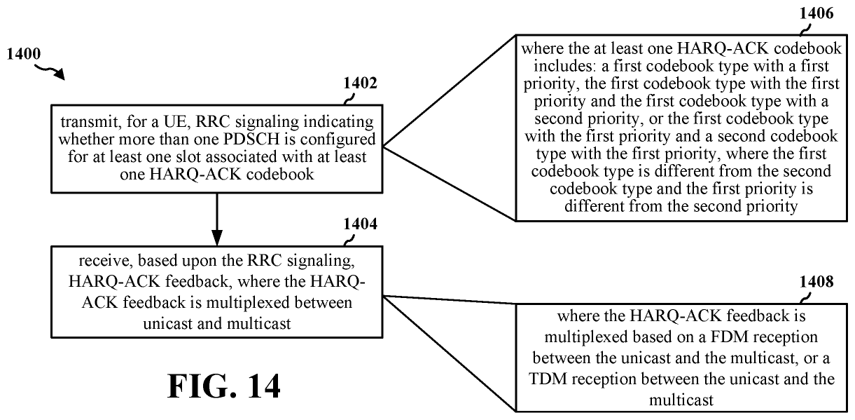

FIG. 14 is a flowchart 1400 of a method of wireless communication. The method may be performed by a network node (e.g., the base station 102, the base station 310, the base station 1004, the network entity 1502, the network entity 1602). In an example, the method (including the various aspects detailed below) may be performed by the HARQ-ACK CB component 199.

At 1402, the network node transmits, for a UE, RRC signaling indicating whether more than one PDSCH is configured for at least one slot associated with at least one HARQ-ACK codebook. For example, FIG. 10 at 1006 shows that the base station 1004 may transmit RRC signaling indicating whether more than one PDSCH is configured for at least one slot associated with at least one HARQ-ACK codebook. In an example, 1402 may be performed by the HARQ-ACK CB component 199.

At 1404, the network node receives, based upon the RRC signaling, HARQ-ACK feedback, where the HARQ-ACK feedback is multiplexed between unicast and multicast. For example, FIG. 10 at 1010 shows that the base station 1004 may receive, based upon the RRC signaling, HARQ-ACK feedback, where the HARQ-ACK feedback is multiplexed between unicast and multicast. In an example, 1404 may be performed by the HARQ-ACK CB component 199.

In one aspect, at 1406, the at least one HARQ-ACK codebook may include: a first codebook type with a first priority, the first codebook type with the first priority and the first codebook type with a second priority, or the first codebook type with the first priority and a second codebook type with the first priority, where the first codebook type is different from the second codebook type and the first priority is different from the second priority. For example, the at least one HARQ-ACK codebook of FIG. 10 may include a first codebook type with a first priority, the first codebook type with the first priority and the first codebook type with a second priority, or the first codebook type with the first priority and a second codebook type with the first priority, where the first codebook type may be different from the second codebook type and the first priority is different from the second priority.

In one aspect, at 1408, the HARQ-ACK feedback may be multiplexed based on a FDM reception between the unicast and the multicast, or a TDM reception between the unicast and the multicast. For example, the FDM reception between the unicast and the multicast or the TDM reception between the unicast and the multicast may include aspects described above in the description of FIG. 4.

In one aspect, the RRC signaling may indicate that the more than one PDSCH is not configured for the at least one slot, where the at least one HARQ-ACK codebook may include a first codebook type with a first priority. For example, the aforementioned aspect may correspond to 610 of FIG. 6.

In one aspect, the RRC signaling may indicate that the more than one PDSCH is not configured for the at least one slot, where the at least one HARQ-ACK codebook may include a first codebook type with a first priority and the first codebook type with a second priority or the at least one HARQ-ACK codebook may include the first codebook type with the first priority and a second codebook type with the first priority. For example, the aforementioned aspect may correspond to 614 of FIG. 6.

In one aspect, the RRC signaling may indicate that the more than one PDSCH is configured for the at least one slot, where the at least one HARQ-ACK codebook may include a first codebook type with a first priority and the first codebook type with a second priority or the at least one HARQ-ACK codebook may include the first codebook type with the first priority and a second codebook type with the first priority. For example, the aforementioned aspect may correspond to 620 of FIG. 6.

In one aspect, the at least one HARQ-ACK codebook may be associated with a mode 1 codebook generation mode or a mode 2 codebook generation mode. For example, the at least one HARQ-ACK codebook of FIG. 10 may be associated with a mode 1 codebook generation mode or a mode 2 codebook generation mode.

In one aspect, the RRC signaling may indicate that the more than one PDSCH is not configured for the at least one slot, where the at least one HARQ-ACK codebook may include a first codebook type with a first priority, where the at least one HARQ-ACK codebook may be associated with a mode 1 codebook generation mode. For example, the aforementioned aspect may correspond to 612 of FIG. 6.

In one aspect, the RRC signaling may indicate that the more than one PDSCH is not configured for the at least one slot, where the at least one HARQ-ACK codebook may include a first codebook type with a first priority, where the at least one HARQ-ACK codebook may be associated with a mode 2 codebook generation mode. For example, the aforementioned aspect may correspond to 612 of FIG. 6.

In one aspect, the RRC signaling may indicate that the more than one PDSCH is configured for the at least one slot, where the at least one HARQ-ACK codebook may include a first codebook type with a first priority, where the at least one HARQ-ACK codebook may be associated with a mode 1 codebook generation mode. For example, the aforementioned aspect may correspond to 622 of FIG. 6.

In one aspect, the RRC signaling may indicate that the more than one PDSCH is configured for the at least one slot, where the at least one HARQ-ACK codebook may include a first codebook type with a first priority, where the at least one HARQ-ACK codebook may be associated with a mode 2 codebook generation mode. For example, the aforementioned aspect may correspond to 622 of FIG. 6.

In one aspect, the RRC signaling may include a first RRC parameter for the unicast and a second RRC parameter for the multicast, where the first RRC parameter for the unicast may indicate whether more than unicast PDSCH is able to be received for the at least one slot, where the second RRC parameter for the multicast may indicate whether more than one multicast PDSCH is able to be received for the at least one slot. For example, the aforementioned aspect may correspond to the example 802 of FIG. 8, where the first RRC parameter of FIG. 8 may be the second RRC parameter above and where the second RRC parameter of FIG. 8 may be the first RRC parameter above.

In one aspect, the first RRC parameter may be associated with a unicast HARQ-ACK sub-codebook, and where the second RRC parameter may be associated with a multicast HARQ-ACK sub-codebook. For example, the second RRC parameter in FIG. 8 may be associated with a unicast HARQ-ACK sub-codebook and the first RRC parameter in FIG. 8 may be associated with a multicast HARQ-ACK sub-codebook.

In one aspect, the RRC signaling may include a first RRC parameter and at least one second RRC parameter, where the first RRC parameter may indicate whether the more than one PDSCH is able to be received for the at least one slot across the unicast and the multicast, where the at least one second RRC parameter may indicate whether the more than one PDSCH is able to be received for the at least one slot for the unicast or for the multicast. For example, the aforementioned aspect may correspond to the first example 902 and/or the second example 912 of FIG. 9.

In one aspect, the at least one HARQ-ACK codebook may be associated with a first sub-codebook for the unicast and the multicast. For example, the aforementioned aspect may correspond to the first example 902 of FIG. 9.

In one aspect, the at least one second RRC parameter may include a second RRC parameter that indicates that the more than one PDSCH is able to be received for the at least one slot for the unicast or for the multicast, where the at least one HARQ-ACK codebook may be further associated with a second sub-codebook for the unicast and a third sub-codebook for the multicast. For example, the aforementioned aspect may correspond to the first example 902 of FIG. 9.

In one aspect, the at least one second RRC parameter may include a second RRC parameter that indicates that the more than one PDSCH is able to be received for the at least one slot for the unicast and a third RRC parameter that indicates that the more than one PDSCH is able to be received for the at least one slot for the multicast, where the at least one HARQ-ACK codebook may be further associated with a second sub-codebook for the unicast and a third sub-codebook for the multicast. For example, the aforementioned aspect may correspond to the second example 912 of FIG. 9.

In one aspect, the RRC signaling indicating whether the more than one PDSCH is configured for the at least one slot associated with the at least one HARQ-ACK codebook may indicate whether the more than one PDSCH is configured for the at least one slot on a per component carrier basis. For example, the RRC signaling transmitted by the base station 1004 at 1006 may indicate whether more than one PDSCH is configured for the at least one slot on a per component carrier basis.

In one aspect, the at least one HARQ-ACK codebook may be a type 1 HARQ-ACK codebook. For example, the at least one HARQ-ACK codebook in FIG. 10 may be a type 1 HARQ-ACK codebook.

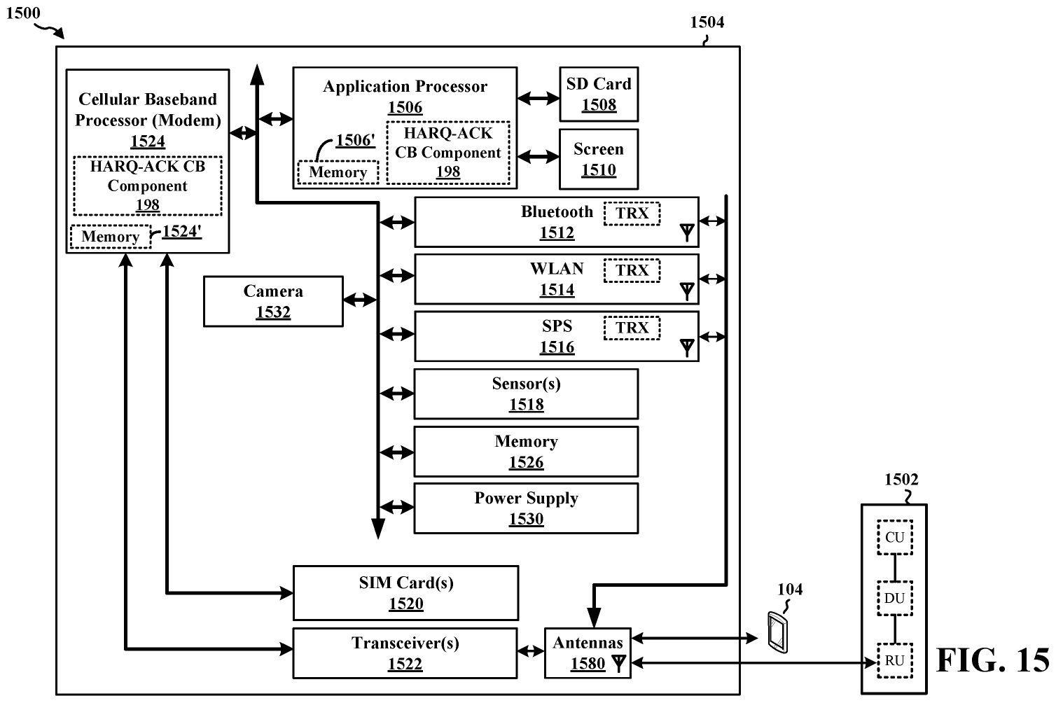

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see UE 350 of FIG. 3) and include the additional modules of the apparatus 1504.

As discussed supra, the HARQ-ACK CB component 198 may be configured to receive RRC signaling indicating whether more than one PDSCH is configured for at least one slot associated with at least one HARQ-ACK codebook. The HARQ-ACK CB component 198 may be configured to perform, for the at least one HARQ-ACK codebook for multiplexing feedback between unicast and multicast for HARQ-ACK, one of: an addition of a candidate PDSCH occasion to a set of candidate PDSCH occasions for the at least one slot based on the RRC signaling; or TDRA grouping for the at least one slot based on the RRC signaling. The HARQ-ACK CB component 198 may be within the cellular baseband processor 1524, the application processor 1506, or both the cellular baseband processor 1524 and the application processor 1506. The HARQ-ACK CB component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, may include means for receiving RRC signaling indicating whether more than one PDSCH is configured for at least one slot associated with at least one HARQ-ACK codebook. In one configuration, the apparatus 1504, and in particular the cellular baseband processor 1524 and/or the application processor 1506, may include means for performing, for the at least one HARQ-ACK codebook for multiplexing feedback between unicast and multicast for HARQ-ACK, one of: an addition of a candidate PDSCH occasion to a set of candidate PDSCH occasions for the at least one slot based on the RRC signaling; or TDRA grouping for the at least one slot based on the RRC signaling. The means may be the HARQ-ACK CB component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

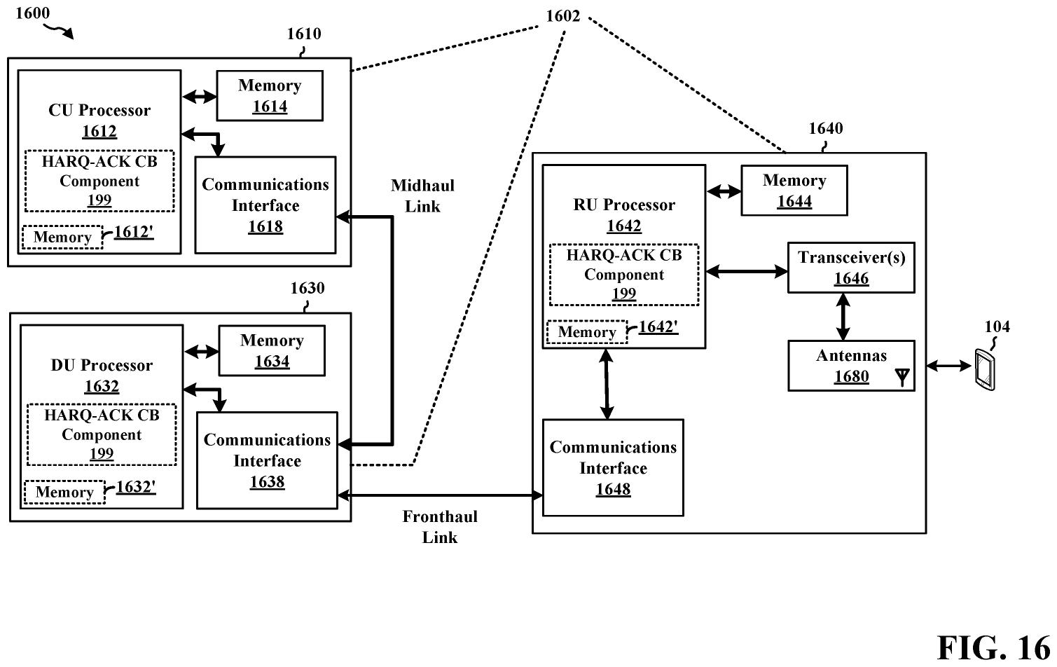

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the HARQ-ACK CB component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the HARQ-ACK CB component 199 may be configured to transmit, for a UE, RRC signaling indicating whether more than one PDSCH is configured for at least one slot associated with at least one HARQ-ACK codebook. The HARQ-ACK CB component 199 may be configured to receive, based upon the RRC signaling, HARQ-ACK feedback, where the HARQ-ACK feedback is multiplexed between unicast and multicast. The HARQ-ACK CB component 199 may be within one or more processors of one or more of the CU 1610, DU 1630, and the RU 1640. The HARQ-ACK CB component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In one configuration, the network entity 1602 may include means for transmitting, for a UE, RRC signaling indicating whether more than one PDSCH is configured for at least one slot associated with at least one HARQ-ACK codebook. In one configuration, the network entity 1602 may include means for receiving, based upon the RRC signaling, HARQ-ACK feedback, where the HARQ-ACK feedback is multiplexed between unicast and multicast. The means may be the HARQ-ACK CB component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

A UE may be configured with the ability to receive one PDSCH per slot or the UE may be configured with the ability to receive more than one PDSCH per slot, where the aforementioned PDSCHs may be or include unicast PDSCHs(s) or multicast PDSCH(s). A manner in which a UE generates a type 1 HARQ-ACK codebook may be affected by whether or not the UE is configured with the ability to receive more than one PDSCH per slot, codebook types associated with multiplexing unicast and multicast HARQ-ACK feedback, priorities associated with codebook types, whether FDM or TDM is used for multiplexing, and/or a type of codebook generation mode. Furthermore, different manners of generating type 1 HARQ-ACK codebooks may result in different sizes for the type 1 HARQ-ACK codebooks. However, a network node may not be able to enable or disable the ability of the UE to receive more than one PDSCH per slot. In an example, a UE that is capable of receiving more than one PDSCH per slot may generate a type 1 HARQ-ACK codebook in a first manner, but the network may not support the capability of the UE receiving more than one PDSCH per slot. As a result, the type 1 HARQ-ACK codebook may have a size that is greater than a size of a type 1 HARQ-ACK codebook that would result had the UE generated the type 1 HARQ-ACK codebook in a second manner associated with the network not supporting the capability of the UE of receiving more than one PDSCH per slot.

Various technologies pertaining to an impact of more than one PDSCH per slot on a HARQ-ACK codebook for multicast are described herein. In an example, a UE receives RRC signaling indicating whether more than one PDSCH is configured for at least one slot associated with at least one HARQ-ACK codebook. The UE performs, for the at least one HARQ-ACK codebook for multiplexing feedback between unicast and multicast for HARQ-ACK, one of: an addition of a candidate PDSCH occasion to a set of candidate PDSCH occasions for the at least one slot based on the RRC signaling; or TDRA grouping for the at least one slot based on the RRC signaling. Vis-à-vis performing an addition of a candidate PDSCH occasion or performing TDRA grouping based on the RRC signaling, the UE may reduce a size of the at least one HARQ-ACK codebook, thus conserving resources of the UE associated with codebook generation.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a user equipment (UE), including: receiving radio resource control (RRC) signaling indicating whether more than one physical downlink shared channel (PDSCH) is configured for at least one slot associated with at least one hybrid automatic repeat request (HARQ) acknowledgment (ACK) (HARQ-ACK) codebook; and performing, for the at least one HARQ-ACK codebook for multiplexing feedback between unicast and multicast for HARQ-ACK, one of: an addition of a candidate PDSCH occasion to a set of candidate PDSCH occasions for the at least one slot based on the RRC signaling; or time domain resource allocation (TDRA) grouping for the at least one slot based on the RRC signaling.
Aspect 2 is the method of aspect 1, where the at least one HARQ-ACK codebook includes: a first codebook type with a first priority, the first codebook type with the first priority and the first codebook type with a second priority, or the first codebook type with the first priority and a second codebook type with the first priority, where the first codebook type is different from the second codebook type and the first priority is different from the second priority.
Aspect 3 is the method of any of aspects 1-2, where the multiplexing feedback is based on a frequency division multiplexing (FDM) reception between the unicast and the multicast, or a time division multiplexing (TDM) reception between the unicast and the multicast.
Aspect 4 is the method of any of aspects 1-3, where the RRC signaling indicates that the more than one PDSCH is not configured for the at least one slot, where the addition of the candidate PDSCH occasion to the set of candidate PDSCH occasions is performed based on the UE being configured for the FDM reception between the unicast and the multicast, and where performing the addition of the candidate PDSCH occasion to the set of candidate PDSCH occasions includes: performing, for the unicast, a first addition of a first candidate PDSCH occasion to the set of candidate PDSCH occasions; and performing, for the multicast, a second addition of a second candidate PDSCH occasion to the set of candidate PDSCH occasions.
Aspect 5 is the method of any of aspects 1-3, where the RRC signaling indicates that the more than one PDSCH is not configured for the at least one slot, where the at least one HARQ-ACK codebook includes a first codebook type with a first priority and the first codebook type with a second priority or the at least one HARQ-ACK codebook includes the first codebook type with the first priority and the second codebook type with the first priority, where performing the addition of the candidate PDSCH occasion to the set of candidate PDSCH occasions includes: performing, for the unicast, a first addition of a first candidate PDSCH occasion to the set of candidate PDSCH occasions; and performing, for the multicast, a second addition of a second candidate PDSCH occasion to the set of candidate PDSCH occasions.
Aspect 6 is the method of any of aspects 1-3, where the RRC signaling indicates that the more than one PDSCH is configured for the at least one slot, where the TDRA grouping is performed based on the UE being configured for the FDM reception between the unicast and the multicast, and where performing the TDRA grouping for the at least one slot includes: performing, for the unicast, a first TDRA grouping for the at least one slot; and performing, for the multicast, a second TDRA grouping for the at least one slot.
Aspect 7 is the method of any of aspects 1-3, where the RRC signaling indicates that the more than one PDSCH is configured for the at least one slot, where the at least one HARQ-ACK codebook includes a first codebook type with a first priority and the first codebook type with a second priority or the at least one HARQ-ACK codebook includes the first codebook type with the first priority and a second codebook type with the first priority, and where performing the TDRA grouping for the at least one slot includes: performing, for the unicast, a first TDRA grouping for the at least one slot; and performing, for the multicast, a second TDRA grouping for the at least one slot.
Aspect 8 is the method of any of aspects 1-3, where the at least one HARQ-ACK codebook is associated with a mode 1 codebook generation mode or a mode 2 codebook generation mode.
Aspect 9 is the method of any of aspects 1-3, where the RRC signaling indicates that the more than one PDSCH is not configured for the at least one slot, where the at least one HARQ-ACK codebook is associated with a mode 1 codebook generation mode, where the addition of the candidate PDSCH occasion to the set of candidate PDSCH occasions is performed based on the UE not being configured for the FDM reception between the unicast and the multicast, and where performing the addition of the candidate PDSCH occasion to the set of candidate PDSCH occasions includes: performing, for the unicast, a first addition of a first candidate PDSCH occasion to the set of candidate PDSCH occasions; performing, for the multicast, a second addition of a second candidate PDSCH occasion to the set of candidate PDSCH occasions; and performing, for the unicast and the multicast, a third addition of a third candidate PDSCH occasion to the set of candidate PDSCH occasions.
Aspect 10 is the method of any of aspects 1-3, where the RRC signaling indicates that the more than one PDSCH is not configured for the at least one slot, where the at least one HARQ-ACK codebook includes a first codebook type with a first priority, where the at least one HARQ-ACK codebook is associated with a mode 2 codebook generation mode, where the addition of the candidate PDSCH occasion to the set of candidate PDSCH occasions is performed based on the UE not being configured for the FDM reception between the unicast and the multicast, and where performing the addition of the candidate PDSCH occasion to the set of candidate PDSCH occasions includes: performing, for the unicast and the multicast, a first addition of a first candidate PDSCH occasion to the set of candidate PDSCH occasions.
Aspect 11 is the method of any of aspects 1-3, where the RRC signaling indicates that the more than one PDSCH is configured for the at least one slot, where the at least one HARQ-ACK codebook includes a first codebook type with a first priority, where the at least one HARQ-ACK codebook is associated with a mode 1 codebook generation mode, where the TDRA grouping is performed based on the UE not being configured for the FDM reception between the unicast and the multicast, and where performing the TDRA grouping for the at least one slot includes: performing, for the unicast, a first TDRA grouping for the at least one slot; performing, for the multicast, a second TDRA grouping for the at least one slot; and performing, for the unicast and the multicast, a third TDRA grouping for the at least one slot.
Aspect 12 is the method of any of aspects 1-3, where the RRC signaling indicates that the more than one PDSCH is configured for the at least one slot, where the at least one HARQ-ACK codebook includes a first codebook type with a first priority, where the at least one HARQ-ACK codebook is associated with a mode 2 codebook generation mode, where the TDRA grouping is performed based on the UE not being configured for the FDM reception between the unicast and the multicast, and where performing the TDRA grouping for the at least one slot includes: performing, for the unicast and the multicast, a first TDRA grouping for the at least one slot.
Aspect 13 is the method of any of aspects 1-12, where the RRC signaling includes a first RRC parameter for the unicast and a second RRC parameter for the multicast, where the first RRC parameter for the unicast indicates whether more than unicast PDSCH is able to be received for the at least one slot, where the second RRC parameter for the multicast indicates whether more than one multicast PDSCH is able to be received for the at least one slot, and where performing one of the addition of the candidate PDSCH occasion to the set of candidate PDSCH occasions or the TDRA grouping for the at least one slot is based on at least one of the first RRC parameter or the second RRC parameter.
Aspect 14 is the method of aspect 13, where the first RRC parameter is associated with a unicast HARQ-ACK sub-codebook, and where the second RRC parameter is associated with a multicast HARQ-ACK sub-codebook.
Aspect 15 is the method of any of aspects 1-12 and 14, where the RRC signaling includes a first RRC parameter and at least one second RRC parameter, where the first RRC parameter indicates whether the more than one PDSCH is able to be received for the at least one slot across the unicast and the multicast, where the at least one second RRC parameter indicates whether the more than one PDSCH is able to be received for the at least one slot for the unicast or for the multicast, and where performing one of the addition of the candidate PDSCH occasion to the set of candidate PDSCH occasions or the TDRA grouping for the at least one slot is based on at least one of the first RRC parameter or the at least one second RRC parameter.
Aspect 16 is the method of aspect 15, where the addition of the candidate PDSCH occasion to the set of candidate PDSCH occasions or the TDRA grouping for the at least one slot is associated with a first sub-codebook of the at least one HARQ-ACK codebook, where the first sub-codebook is for the unicast and the multicast, and where performing one of the addition of the candidate PDSCH occasion to the set of candidate PDSCH occasions or the TDRA grouping for the at least one slot is based on the first RRC parameter.
Aspect 17 is the method of aspect 16, where the at least one second RRC parameter includes a second RRC parameter that indicates that the more than one PDSCH is able to be received for the at least one slot for the unicast or for the multicast, where the addition of the candidate PDSCH occasion to the set of candidate PDSCH occasions or the TDRA grouping for the at least one slot is associated with a second sub-codebook and a third sub-codebook of the at least one HARQ-ACK codebook, where the second sub-codebook is for the unicast and the third sub-codebook is for the multicast, and where performing one of the addition of the candidate PDSCH occasion to the set of candidate PDSCH occasions or the TDRA grouping for the at least one slot is based on the second RRC parameter.
Aspect 18 is the method of aspect 16, where the at least one second RRC parameter includes a second RRC parameter that indicates that the more than one PDSCH is able to be received for the at least one slot for the unicast and a third RRC parameter that indicates that the more than one PDSCH is able to be received for the at least one slot for the multicast, where the addition of the candidate PDSCH occasion to the set of candidate PDSCH occasions or the TDRA grouping for the at least one slot is associated with a second sub-codebook and a third sub-codebook of the at least one HARQ-ACK codebook, where the second sub-codebook is for the unicast and the third sub-codebook is for the multicast, and where performing one of the addition of the candidate PDSCH occasion to the set of candidate PDSCH occasions or the TDRA grouping for the at least one slot is based on the second RRC parameter and the third RRC parameter.
Aspect 19 is the method of any of aspects 1-18, where the RRC signaling indicating whether the more than one PDSCH is configured for the at least one slot associated with the at least one HARQ-ACK codebook indicates whether the more than one PDSCH is configured for the at least one slot on a per component carrier basis.
Aspect 20 is the method of any of aspects 1-19, where the at least one HARQ-ACK codebook is a type 1 HARQ-ACK codebook.
Aspect 21 is an apparatus for wireless communication at a user equipment (UE), including at least one memory and at least one processor coupled to the at least one memory and, based at least in part on information stored in the at least one memory, the at least one processor, individually or in any combination, is configured to perform a method as in any of aspects 1-20.
Aspect 22 is the apparatus of aspect 21, further including at least one of a transceiver or an antenna coupled to the at least one processor, where to receive the RRC signaling, the at least one processor, individually or in any combination, is configured to receive the RRC signaling via at least one of the transceiver or the antenna.
Aspect 23 is an apparatus for wireless communication at a user equipment (UE), including means for performing a method as in any of aspects 1-20.
Aspect 24 is a computer-readable medium (e.g., a non-transitory computer-readable medium) storing computer executable code, the computer executable code when executed by at least one processor causes the at least one processor to implement a method as in any of aspects 1-20.
Aspect 25 is a method of wireless communication at a network node, including, transmitting, for a user equipment (UE), radio resource control (RRC) signaling indicating whether more than one physical downlink shared channel (PDSCH) is configured for at least one slot associated with at least one hybrid automatic repeat request (HARQ) acknowledgment (ACK) (HARQ-ACK) codebook; and receiving, based upon the RRC signaling, HARQ-ACK feedback, where the HARQ-ACK feedback is multiplexed between unicast and multicast.
Aspect 26 is the method of aspect 25, where the at least one HARQ-ACK codebook includes: a first codebook type with a first priority, the first codebook type with the first priority and the first codebook type with a second priority, or the first codebook type with the first priority and a second codebook type with the first priority, where the first codebook type is different from the second codebook type and the first priority is different from the second priority.
Aspect 27 is the method of any of aspects 25-26, where the HARQ-ACK feedback is multiplexed based on a frequency division multiplexing (FDM) reception between the unicast and the multicast, or a time division multiplexing (TDM) reception between the unicast and the multicast.
Aspect 28 is the method of any of aspects 25-27, where the RRC signaling indicates that the more than one PDSCH is not configured for the at least one slot, where the at least one HARQ-ACK codebook includes a first codebook type with a first priority.
Aspect 29 is the method of any of aspects 25-27, where the RRC signaling indicates that the more than one PDSCH is not configured for the at least one slot, where the at least one HARQ-ACK codebook includes a first codebook type with a first priority and the first codebook type with a second priority or the at least one HARQ-ACK codebook includes the first codebook type with the first priority and a second codebook type with the first priority.
Aspect 30 is the method of any of aspects 25-27, where the RRC signaling indicates that the more than one PDSCH is configured for the at least one slot, where the at least one HARQ-ACK codebook includes a first codebook type with a first priority and the first codebook type with a second priority or the at least one HARQ-ACK codebook includes the first codebook type with the first priority and a second codebook type with the first priority.
Aspect 31 is the method of any of aspects 25-27, where the at least one HARQ-ACK codebook is associated with a mode 1 codebook generation mode or a mode 2 codebook generation mode.
Aspect 32 is the method of any of aspects 25-27, where the RRC signaling indicates that the more than one PDSCH is not configured for the at least one slot, where the at least one HARQ-ACK codebook includes a first codebook type with a first priority, where the at least one HARQ-ACK codebook is associated with a mode 1 codebook generation mode.
Aspect 33 is the method of any of aspects 25-27, where the RRC signaling indicates that the more than one PDSCH is not configured for the at least one slot, where the at least one HARQ-ACK codebook includes a first codebook type with a first priority, where the at least one HARQ-ACK codebook is associated with a mode 2 codebook generation mode.
Aspect 34 is the method of any of aspects 25-27, where the RRC signaling indicates that the more than one PDSCH is configured for the at least one slot, where the at least one HARQ-ACK codebook includes a first codebook type with a first priority, where the at least one HARQ-ACK codebook is associated with a mode 1 codebook generation mode.
Aspect 35 is the method of any of aspects 25-27, where the RRC signaling indicates that the more than one PDSCH is configured for the at least one slot, where the at least one HARQ-ACK codebook includes a first codebook type with a first priority, where the at least one HARQ-ACK codebook is associated with a mode 2 codebook generation mode.
Aspect 36 is the method of any of aspects 25-35, where the RRC signaling includes a first RRC parameter for the unicast and a second RRC parameter for the multicast, where the first RRC parameter for the unicast indicates whether more than unicast PDSCH is able to be received for the at least one slot, where the second RRC parameter for the multicast indicates whether more than one multicast PDSCH is able to be received for the at least one slot.
Aspect 37 is the method of aspect 36, where the first RRC parameter is associated with a unicast HARQ-ACK sub-codebook, and where the second RRC parameter is associated with a multicast HARQ-ACK sub-codebook.
Aspect 38 is the method of any of aspects 25-35 and 37, where the RRC signaling includes a first RRC parameter and at least one second RRC parameter, where the first RRC parameter indicates whether the more than one PDSCH is able to be received for the at least one slot across the unicast and the multicast, where the at least one second RRC parameter indicates whether the more than one PDSCH is able to be received for the at least one slot for the unicast or for the multicast.
Aspect 39 is the method of aspect 38, where the at least one HARQ-ACK codebook is associated with a first sub-codebook for the unicast and the multicast.
Aspect 40 is the method of aspect 38, where the at least one second RRC parameter includes a second RRC parameter that indicates that the more than one PDSCH is able to be received for the at least one slot for the unicast or for the multicast, where the at least one HARQ-ACK codebook is further associated with a second sub-codebook for the unicast and a third sub-codebook for the multicast.
Aspect 41 is the method of aspect 38, where the at least one second RRC parameter includes a second RRC parameter that indicates that the more than one PDSCH is able to be received for the at least one slot for the unicast and a third RRC parameter that indicates that the more than one PDSCH is able to be received for the at least one slot for the multicast, where the at least one HARQ-ACK codebook is further associated with a second sub-codebook for the unicast and a third sub-codebook for the multicast.
Aspect 42 is the method of any of aspects 25-42, where the RRC signaling indicating whether the more than one PDSCH is configured for the at least one slot associated with the at least one HARQ-ACK codebook indicates whether the more than one PDSCH is configured for the at least one slot on a per component carrier basis.
Aspect 43 is the method of any of aspects 25-43, where the at least one HARQ-ACK codebook is a type 1 HARQ-ACK codebook.
Aspect 44 is an apparatus for wireless communication at a network node, including at least one memory and at least one processor coupled to the at least one memory and, based at least in part on information stored in the at least one memory, the at least one processor, individually or in any combination, is configured to perform a method as in any of aspects 25-43.
Aspect 45 is the apparatus of aspect 44, further including at least one of a transceiver or an antenna coupled to the at least one processor, where to transmit the RRC signaling, the at least one processor, individually or in any combination, is configured to receive the RRC signaling via at least one of the transceiver or the antenna.
Aspect 46 is an apparatus for wireless communication at a network node, including means for performing a method as in any of aspects 25-43.
Aspect 47 is a computer-readable medium (e.g., a non-transitory computer-readable medium) storing computer executable code, the computer executable code when executed by at least one processor causes the at least one processor to implement a method as in any of aspects 25-43.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive radio resource control (RRC) signaling indicating whether more than one physical downlink shared channel (PDSCH) is configured for at least one slot associated with at least one hybrid automatic repeat request (HARQ) acknowledgment (ACK) (HARQ-ACK) codebook; and
perform, for the at least one HARQ-ACK codebook for multiplexing feedback between unicast and multicast for HARQ-ACK, one of:
an addition of a candidate PDSCH occasion to a set of candidate PDSCH occasions for the at least one slot based on the RRC signaling; or
time domain resource allocation (TDRA) grouping for the at least one slot based on the RRC signaling.

2. The apparatus of claim 1, wherein the at least one HARQ-ACK codebook includes: a first codebook type with a first priority, the first codebook type with the first priority and the first codebook type with a second priority, or the first codebook type with the first priority and a second codebook type with the first priority, wherein the first codebook type is different from the second codebook type and the first priority is different from the second priority.

3. The apparatus of claim 1, wherein the multiplexing feedback is based on a frequency division multiplexing (FDM) reception between the unicast and the multicast, or a time division multiplexing (TDM) reception between the unicast and the multicast.

4. The apparatus of claim 1, wherein the RRC signaling indicates that the more than one PDSCH is not configured for the at least one slot, wherein to perform the addition of the candidate PDSCH occasion to the set of candidate PDSCH occasions, the at least one processor, individually or in any combination, is configured to perform the addition of the candidate PDSCH occasion to the set of candidate PDSCH occasions based on the UE being configured for frequency division multiplexing (FDM) reception between the unicast and the multicast, and wherein to perform the addition of the candidate PDSCH occasion to the set of candidate PDSCH occasions, the at least one processor, individually or in any combination, is configured to:
perform, for the unicast, a first addition of a first candidate PDSCH occasion to the set of candidate PDSCH occasions; and
perform, for the multicast, a second addition of a second candidate PDSCH occasion to the set of candidate PDSCH occasions.

5. The apparatus of claim 1, wherein the RRC signaling indicates that the more than one PDSCH is not configured for the at least one slot, wherein the at least one HARQ-ACK codebook includes a first codebook type with a first priority and the first codebook type with a second priority or the at least one HARQ-ACK codebook includes the first codebook type with the first priority and a second codebook type with the first priority, wherein to perform the addition of the candidate PDSCH occasion to the set of candidate PDSCH occasions, the at least one processor, individually or in any combination, is configured to:
perform, for the unicast, a first addition of a first candidate PDSCH occasion to the set of candidate PDSCH occasions; and
perform, for the multicast, a second addition of a second candidate PDSCH occasion to the set of candidate PDSCH occasions.

6. The apparatus of claim 1, wherein the RRC signaling indicates that the more than one PDSCH is configured for the at least one slot, wherein to perform the TDRA grouping, the at least one processor, individually or in any combination, is configured to perform the TDRA grouping based on the UE being configured for frequency division multiplexing (FDM) reception between the unicast and the multicast, and wherein to perform the TDRA grouping for the at least one slot, the at least one processor, individually or in any combination, is configured to:
perform, for the unicast, a first TDRA grouping for the at least one slot; and
perform, for the multicast, a second TDRA grouping for the at least one slot.

7. The apparatus of claim 1, wherein the RRC signaling indicates that the more than one PDSCH is configured for the at least one slot, wherein the at least one HARQ-ACK codebook includes a first codebook type with a first priority and the first codebook type with a second priority or the at least one HARQ-ACK codebook includes the first codebook type with the first priority and a second codebook type with the first priority, and wherein to perform the TDRA grouping for the at least one slot, the at least one processor, individually or in any combination, is configured to:
perform, for the unicast, a first TDRA grouping for the at least one slot; and
perform, for the multicast, a second TDRA grouping for the at least one slot.

8. The apparatus of claim 1, wherein the at least one HARQ-ACK codebook is associated with a mode 1 codebook generation mode or a mode 2 codebook generation mode.

9. The apparatus of claim 1, wherein the RRC signaling indicates that the more than one PDSCH is not configured for the at least one slot, wherein the at least one HARQ-ACK codebook is associated with a mode 1 codebook generation mode, wherein to perform the addition of the candidate PDSCH occasion to the set of candidate PDSCH occasions, the at least one processor, individually or in any combination, is configured to perform the addition of the candidate PDSCH occasion to the set of candidate PDSCH occasions based on the UE not being configured for frequency division multiplexing (FDM) reception between the unicast and the multicast, and wherein to perform the addition of the candidate PDSCH occasion to the set of candidate PDSCH occasions, the at least one processor, individually or in any combination, is configured to:
perform, for the unicast, a first addition of a first candidate PDSCH occasion to the set of candidate PDSCH occasions;
perform, for the multicast, a second addition of a second candidate PDSCH occasion to the set of candidate PDSCH occasions; and
perform, for the unicast and the multicast, a third addition of a third candidate PDSCH occasion to the set of candidate PDSCH occasions.

10. The apparatus of claim 1, wherein the RRC signaling indicates that the more than one PDSCH is not configured for the at least one slot, wherein the at least one HARQ-ACK codebook includes a first codebook type with a first priority, wherein the at least one HARQ-ACK codebook is associated with a mode 2 codebook generation mode, wherein to perform the addition of the candidate PDSCH occasion to the set of candidate PDSCH occasions, the at least one processor, individually or in any combination, is configured to perform the addition of the candidate PDSCH occasion to the set of candidate PDSCH occasions based on the UE not being configured for frequency division multiplexing (FDM) reception between the unicast and the multicast, and wherein to perform the addition of the candidate PDSCH occasion to the set of candidate PDSCH occasions, the at least one processor, individually or in any combination, is configured to:
perform, for the unicast and the multicast, a first addition of a first candidate PDSCH occasion to the set of candidate PDSCH occasions.

11. The apparatus of claim 1, wherein the RRC signaling indicates that the more than one PDSCH is configured for the at least one slot, wherein the at least one HARQ-ACK codebook includes a first codebook type with a first priority, wherein the at least one HARQ-ACK codebook is associated with a mode 1 codebook generation mode, wherein to perform the TDRA grouping, the at least one processor, individually or in any combination, is configured to perform the TDRA grouping based on the UE not being configured for frequency division multiplexing (FDM) reception between the unicast and the multicast, and wherein to perform the TDRA grouping for the at least one slot, the at least one processor, individually or in any combination, is configured to:
perform, for the unicast, a first TDRA grouping for the at least one slot;
perform, for the multicast, a second TDRA grouping for the at least one slot; and
perform, for the unicast and the multicast, a third TDRA grouping for the at least one slot.

12. The apparatus of claim 1, wherein the RRC signaling indicates that the more than one PDSCH is configured for the at least one slot, wherein the at least one HARQ-ACK codebook includes a first codebook type with a first priority, wherein the at least one HARQ-ACK codebook is associated with a mode 2 codebook generation mode, wherein to perform the TDRA grouping, the at least one processor, individually or in any combination, is configured to perform the TDRA grouping based on the UE not being configured for frequency division multiplexing (FDM) reception between the unicast and the multicast, and wherein to perform the TDRA grouping for the at least one slot, the at least one processor, individually or in any combination, is configured to:
perform, for the unicast and the multicast, a first TDRA grouping for the at least one slot.

13. The apparatus of claim 1, wherein the RRC signaling comprises a first RRC parameter for the unicast and a second RRC parameter for the multicast, wherein the first RRC parameter for the unicast indicates whether more than unicast PDSCH is able to be received for the at least one slot, wherein the second RRC parameter for the multicast indicates whether more than one multicast PDSCH is able to be received for the at least one slot, and wherein to perform one of the addition of the candidate PDSCH occasion to the set of candidate PDSCH occasions or the TDRA grouping for the at least one slot, the at least one processor, individually or in any combination, is configured to perform one of the addition of the candidate PDSCH occasion to the set of candidate PDSCH occasions or the TDRA grouping for the at least one slot based on at least one of the first RRC parameter or the second RRC parameter.

14. The apparatus of claim 13, wherein the first RRC parameter is associated with a unicast HARQ-ACK sub-codebook, and wherein the second RRC parameter is associated with a multicast HARQ-ACK sub-codebook.

15. The apparatus of claim 1, wherein the RRC signaling comprises a first RRC parameter and at least one second RRC parameter, wherein the first RRC parameter indicates whether the more than one PDSCH is able to be received for the at least one slot across the unicast and the multicast, wherein the at least one second RRC parameter indicates whether the more than one PDSCH is able to be received for the at least one slot for the unicast or for the multicast, and wherein to perform one of the addition of the candidate PDSCH occasion to the set of candidate PDSCH occasions or the TDRA grouping for the at least one slot, the at least one processor, individually or in any combination, is configured to perform one of the addition of the candidate PDSCH occasion to the set of candidate PDSCH occasions or the TDRA grouping for the at least one slot based on at least one of the first RRC parameter or the at least one second RRC parameter.

16. The apparatus of claim 15, wherein the addition of the candidate PDSCH occasion to the set of candidate PDSCH occasions or the TDRA grouping for the at least one slot is associated with a first sub-codebook of the at least one HARQ-ACK codebook, wherein the first sub-codebook is for the unicast and the multicast, and wherein to perform one of the addition of the candidate PDSCH occasion to the set of candidate PDSCH occasions or the TDRA grouping for the at least one slot, the at least one processor, individually or in any combination, is configured to perform one of the addition of the candidate PDSCH occasion to the set of candidate PDSCH occasions or the TDRA grouping for the at least one slot based on the first RRC parameter.

17. The apparatus of claim 16, wherein the at least one second RRC parameter comprises a second RRC parameter that indicates that the more than one PDSCH is able to be received for the at least one slot for the unicast or for the multicast, wherein the addition of the candidate PDSCH occasion to the set of candidate PDSCH occasions or the TDRA grouping for the at least one slot is associated with a second sub-codebook and a third sub-codebook of the at least one HARQ-ACK codebook, wherein the second sub-codebook is for the unicast and the third sub-codebook is for the multicast, and wherein to perform one of the addition of the candidate PDSCH occasion to the set of candidate PDSCH occasions or the TDRA grouping for the at least one slot, the at least one processor, individually or in any combination, is configured to perform one of the addition of the candidate PDSCH occasion to the set of candidate PDSCH occasions or the TDRA grouping for the at least one slot based on the second RRC parameter.

18. The apparatus of claim 16, wherein the at least one second RRC parameter comprises a second RRC parameter that indicates that the more than one PDSCH is able to be received for the at least one slot for the unicast and a third RRC parameter that indicates that the more than one PDSCH is able to be received for the at least one slot for the multicast, wherein the addition of the candidate PDSCH occasion to the set of candidate PDSCH occasions or the TDRA grouping for the at least one slot is associated with a second sub-codebook and a third sub-codebook of the at least one HARQ-ACK codebook, wherein the second sub-codebook is for the unicast and the third sub-codebook is for the multicast, and wherein to perform one of the addition of the candidate PDSCH occasion to the set of candidate PDSCH occasions or the TDRA grouping for the at least one slot, the at least one processor, individually or in any combination, is configured to perform one of the addition of the candidate PDSCH occasion to the set of candidate PDSCH occasions or the TDRA grouping for the at least one slot based on the second RRC parameter and the third RRC parameter.

19. The apparatus of claim 1, wherein the RRC signaling indicating whether the more than one PDSCH is configured for the at least one slot associated with the at least one HARQ-ACK codebook indicates whether the more than one PDSCH is configured for the at least one slot on a per component carrier basis.

20. The apparatus of claim 1, wherein the at least one HARQ-ACK codebook is a type 1 HARQ-ACK codebook.

21. The apparatus of claim 1, wherein the apparatus comprises at least one of a transceiver or an antenna coupled to the at least one processor, and wherein to receive the RRC signaling, the at least one processor, individually or in any combination, is configured to receive the RRC signaling via at least one of the transceiver or the antenna.

22. An apparatus for wireless communication at a network node, comprising:
at least one memory; and
at least one processor coupled to the at least one memory and, based at least in part on information stored in the at least one memory, the at least one processor, individually or in any combination, is configured to:
transmit, for a user equipment (UE), radio resource control (RRC) signaling indicating whether more than one physical downlink shared channel (PDSCH) is configured for at least one slot associated with at least one hybrid automatic repeat request (HARQ) acknowledgment (ACK) (HARQ-ACK) codebook; and
receive, based upon the RRC signaling, HARQ-ACK feedback, wherein
the HARQ-ACK feedback is multiplexed between unicast and multicast.

23. The apparatus of claim 22, wherein the at least one HARQ-ACK codebook includes: a first codebook type with a first priority, the first codebook type with the first priority and the first codebook type with a second priority, or the first codebook type with the first priority and a second codebook type with the first priority, wherein the first codebook type is different from the second codebook type and the first priority is different from the second priority.

24. The apparatus of claim 22, wherein the HARQ-ACK feedback is multiplexed based on a frequency division multiplexing (FDM) reception between the unicast and the multicast, or a time division multiplexing (TDM) reception between the unicast and the multicast.

25. The apparatus of claim 22, wherein the RRC signaling indicates that the more than one PDSCH is not configured for the at least one slot, wherein the at least one HARQ-ACK codebook includes a first codebook type with a first priority.

26. The apparatus of claim 22, wherein the RRC signaling indicates that the more than one PDSCH is not configured for the at least one slot, wherein the at least one HARQ-ACK codebook includes a first codebook type with a first priority and the first codebook type with a second priority or the at least one HARQ-ACK codebook includes the first codebook type with the first priority and the second codebook type with the first priority.

27. The apparatus of claim 22, wherein the RRC signaling indicates that the more than one PDSCH is configured for the at least one slot, wherein the at least one HARQ-ACK codebook includes a first codebook type with a first priority and the first codebook type with a second priority or the at least one HARQ-ACK codebook includes the first codebook type with the first priority and a second codebook type with the first priority.

28. The apparatus of claim 22, wherein the apparatus comprises at least one of a transceiver or an antenna coupled to the at least one processor, and wherein to transmit the RRC signaling, the at least one processor, individually or in any combination, is configured to receive the RRC signaling via at least one of the transceiver or the antenna.

29. A method of wireless communication at a user equipment (UE), comprising:
receiving radio resource control (RRC) signaling indicating whether more than one physical downlink shared channel (PDSCH) is configured for at least one slot associated with at least one hybrid automatic repeat request (HARQ) acknowledgment (ACK) (HARQ-ACK) codebook; and
performing, for the at least one HARQ-ACK codebook for multiplexing feedback between unicast and multicast for HARQ-ACK, one of:
an addition of a candidate PDSCH occasion to a set of candidate PDSCH occasions for the at least one slot based on the RRC signaling; or
time domain resource allocation (TDRA) grouping for the at least one slot based on the RRC signaling.

30. A method of wireless communication at a network node, comprising,
transmitting, for a user equipment (UE), radio resource control (RRC) signaling indicating whether more than one physical downlink shared channel (PDSCH) is configured for at least one slot associated with at least one hybrid automatic repeat request (HARQ) acknowledgment (ACK) (HARQ-ACK) codebook; and
receiving, based upon the RRC signaling, HARQ-ACK feedback, wherein the HARQ-ACK feedback is multiplexed between unicast and multicast.
